(19) United States
(12) Patent Application Publication
(10) Pub. No.: US 2021/0001278 A1
(43) Pub. Date: Jan. 7, 2021

(54) METHODS OF MAKING POROUS MEMBRANES

(71) Applicant: King Abdullah University of Science and Technology, Thuwal (SA)

(72) Inventors: Zhiping LAI, Thuwal (SA); Roshni Lilly THANKAMONY, Thuwal (SA)

(21) Appl. No.: 16/767,809

(22) PCT Filed: Dec. 4, 2018
(86) PCT No.: PCT/IB2018/059635

§ 371 Date: May 28, 2020

Related U.S. Application Data
(60) Provisional application No. 62/594,195, filed on Dec. 4, 2017.
(60) Provisional application No. 62/621,155, filed on Jan. 24, 2018.
(60) Provisional application No. 62/633,247, filed on Feb. 21, 2018.

(51) Int. Cl. B01D 67/00; B01D 69/02

(52) U.S. Cl. CPC B01D 67/0011; B01D 69/02; B01D 67/0079; B01D 2323/22; B01D 2325/36; B01D 2325/022; B01D 2323/08

(57) ABSTRACT

Embodiments of the present disclosure describe a method of making a membrane comprising contacting one or more membrane materials, a solvent, and a non-solvent at a first temperature sufficient to form a homogenous solution; casting the homogenous solution at about the first temperature; and adjusting the temperature to a second temperature sufficient to induce phase separation of the solvent and non-solvent and form a porous membrane.

### BACKGROUND

Creating controlled nanoscale porous structures on various substrates has an unprecedentedly significant role in contemporary membrane research and applied technologies such as ultrafiltration, porous membrane support, molds or scaffoldings, and model substrates for surface science. Porous membranes with regular pore sizes in the sub-micrometer range (1-1000 nm) are crucial for their broad applications in protein separation and purification, cold disinfection, removal of colloidal particle, biomolecule detection, drug delivery, electronic, catalysis, etc.

The most widely used large-scale methods for preparing polymeric membranes are non-solvent induced phase separation (NIPS) and temperature induced phase separation (TIPS). Both methods are able to generate sponge-like or fingering-like porous structures in the bulk, with a surface layer that is typically dense or characterized by very low porosity. Techniques such as photo lithography, breath figures, and introduction of pore forming agents such as polyvinylpyrrolidon (PVP), methyl cellosolve, PEG etc. have been limited to micrometer sized surface pores. Those techniques have not been able to generate regular surface pores in the nanometer range.

The only known methods capable of generating regular surface pores in the nanometer pore size range include track-etching by high-energy particles, anodic oxidation under electrical field, and self-assembling of block co-polymers. Track-etched polycarbonate (PCTE) membranes and aluminum anodic oxidation membranes (AAO) are commercially available. However, the surface porosity of PCTE is very low, which limits its flux, and AAO is very brittle and thin, which limits its scalability and operating pressure. The self-assembly of block-copolymers is a method that is able to produce perpendicular isopores on the membrane surface area. This method can also be combined with the NIPS process to fabricate polymer membranes in large scale. However, block co-polymers are very expensive, and their long-term stability in membrane applications is unclear and yet to be proved.

The most commonly used polymer membranes are made from homopolymers such as PVDF, cellulose acetate, polyamide, polyimide, etc. Generating porous structure out of these materials is highly desirable.

### SUMMARY

In general, embodiments of the present disclosure describe porous membranes, methods of making porous membranes, and methods of using porous membranes (e.g., masks for removing particulate matters).

Accordingly, embodiments of the present disclosure describe a method of making a membrane comprising contacting one or more membrane materials, a solvent, and a non-solvent at a first temperature sufficient to form a homogenous solution; casting the homogenous solution at about the first temperature; and adjusting the temperature to a second temperature sufficient to induce phase separation of the solvent and non-solvent and form a porous membrane.

Embodiments of the present disclosure further describe a method of making a membrane comprising contacting one or more membrane materials, a solvent, and a non-solvent at a first temperature sufficient to form a homogenous solution, wherein the solvent and non-solvent are miscible at the first temperature; casting the homogenous solution at about the first temperature; and adjusting the temperature to a second temperature sufficient to induce phase separation of the solvent and non-solvent and form a porous membrane, wherein the solvent and non-solvent are immiscible at the second temperature.

Embodiments of the present disclosure also describe a method of making a membrane comprising contacting one or more membrane materials, a solvent, and a non-solvent at a first temperature sufficient to form a homogenous solution, wherein the first temperature is a temperature above an upper critical solution temperature; casting the homogenous solution at about the first temperature; and adjusting the temperature to a second temperature sufficient to induce phase separation of the solvent and non-solvent and form a porous membrane, wherein the second temperature is a temperature below the upper critical solution temperature.

Embodiments of the present disclosure also describe a method of making a membrane comprising contacting one or more membrane materials, a solvent, and a non-solvent at a first temperature sufficient to form a homogenous solution, wherein the first temperature is a temperature above a lower critical solution temperature; casting the homogenous solution at about the first temperature; and adjusting the temperature to a second temperature sufficient to induce phase separation of the solvent and non-solvent and form a porous membrane, wherein the second temperature is a temperature below the lower critical solution temperature.

Embodiments of the present disclosure describe a method of making a porous membrane comprising contacting one or more membrane materials, a solvent, and a non-solvent at a first temperature sufficient to form a homogenous solution, wherein the first temperature is a temperature above an upper critical solution temperature; casting the homogenous solution at about the first temperature; and adjusting the temperature to a second temperature sufficient to induce phase separation of the solvent and non-solvent and form a porous membrane, wherein the second temperature is a temperature below the upper critical solution temperature.

Embodiments of the present disclosure describe a method of making a porous membrane comprising contacting one or more membrane materials, a solvent, and a non-solvent at a first temperature sufficient to form a homogenous solution, wherein the first temperature is a temperature above a lower critical solution temperature; casting the homogenous solution at about the first temperature; and adjusting the temperature to a second temperature sufficient to induce phase separation of the solvent and non-solvent and form a porous membrane, wherein the second temperature is a temperature below the lower critical solution temperature.

Embodiments of the present disclosure describe a method of making a membrane comprising contacting one or more of polyvinylidene fluoride (PVDF), cellulose acetate (CA), alumina powder, N-Methyl-2-pyrrolidone (NMP), polyvinyl pyrrolidone (PVP), dimethylformamide (DMF), and octane at a first temperature sufficient to form a homogeneous solution; casting the homogenous solution at about the first temperature; and adjusting the temperature to a second temperature sufficient to induce phase separation of the solvent and non-solvent and form a porous membrane.

Embodiments of the present disclosure describe a mask for removing particulate matters comprising a porous polymer membrane comprising one or more of polyvinylidene fluoride (PVDF) and cellulose acetate (CA).

The details of one or more examples are set forth in the description below. Other features, objects, and advantages will be apparent from the description and from the claims.

### BRIEF DESCRIPTION OF DRAWINGS

This written disclosure describes illustrative embodiments that are non-limiting and non-exhaustive. In the drawings, which are not necessarily drawn to scale, like numerals describe substantially similar components throughout the several views. Like numerals having different letter suffixes represent different instances of substantially similar components. The drawings illustrate generally, by way of example, but not by way of limitation, various embodiments discussed in the present document.

Reference is made to illustrative embodiments that are depicted in the figures, in which:

FIG. 1 is a flowchart of a method of making a porous membrane, according to one or more embodiments of the present disclosure.

FIG. 2 is a flowchart of a method of making a porous membrane, wherein the method optionally comprises immersing the porous membrane in a bath, according to one or more embodiments of the present disclosure.

FIG. 3 is a flowchart of a method of making a porous membrane, wherein the method optionally comprises one or more of immersing the porous membrane in a bath and removing one or more solvents from the porous membrane, according to one or more embodiments of the present disclosure.

FIG. 4 is a SEM image of the top surface of a porous PVDF membrane, according to one or more embodiments of the present disclosure.

FIG. 5 is a SEM image of a cross-section of a porous PVDF membrane, according to one or more embodiments of the present disclosure.

FIG. 6 is a graphical view of pore size distribution of a porous PVDF membrane, according to one or more embodiments of the present disclosure.

FIG. 7 is a SEM image of the top surface of a porous cellulose acetate membrane, according to one or more embodiments of the present disclosure.

FIG. 8 is a SEM image of a cross-section of a porous cellulose acetate membrane, according to one or more embodiments of the present disclosure.

FIG. 9 is a graphical view of pore size distribution of a porous cellulose acetate membrane, according to one or more embodiments of the present disclosure.

FIG. 10 is a SEM image of the top surface of a porous PVDF/porous cellulose acetate composite membrane, according to one or more embodiments of the present disclosure.

FIG. 11 is a SEM image of a cross-section of a porous PVDF/porous cellulose acetate composite membrane, according to one or more embodiments of the present disclosure.

FIG. 12 is a graphical view of pore size distribution of a porous PVDF/porous cellulose acetate composite membrane, according to one or more embodiments of the present disclosure.

FIG. 13 is a schematic diagram of a novel MSPS process for fabrication of highly porous ultrafiltration membranes, according to one or more embodiments of the present disclosure.

FIG. 14 shows images of UCST behavior for two immiscible solvents (DMF and octane) using dye as a marker, according to one or more embodiments of the present disclosure.

FIG. 15 is a graphical view showing the Gibbs free energy at T=320 K for the DMF/octane system, where the orange line connects the two phases in equilibrium, according to one or more embodiments of the present disclosure.

FIGS. 16A-16H shows: (a) DMF and octane phase diagram where the red vertical dashed line indicates the mole fraction of DMF in the casting solution and phase evolution during the membrane casting procedure; (b) schematic of the MSPS membrane fabrication process; (c) top view of the MSPS PVDF membrane where the inset is a magnified image; (d) pore size distribution of the MSPS PVDF membrane; (e) cross-section of the MSPS PVDF membrane; (f) top view of the MSPS PVDF/CA membrane; (g) pore size distribution of the MSPS PVDF/CA membrane; and (h) cross-section of the MSPS PVDF/CA membrane, according to one or more embodiments of the present disclosure.

FIGS. 17A-17B shows high magnification cross-section images close to the top layer of (a) MSPS PVDF membrane, and (b) MSPS PVDF/CA membrane, according to one or more embodiments of the present disclosure.

FIG. 18 is a graphical view showing the water contact angle of PVDF and PVDF/CA membranes made by NIPS and MSPS methods, according to one or more embodiments of the present disclosure.

FIGS. 19A-19D show a comparison of membranes formed in different solvent systems: (a) DMF alone, (b) DMF/pyridine, (c) DMF/toluene, and (d) DMF/nonane, according to one or more embodiments of the present disclosure.

FIGS. 20A-20F show, in the top three images, simulated patterns at different evolution steps: (a) 10,000, (b) 20,000, and (c) 60,000 times, based on the CH equation (The equivalent time interval was 3×10⁻³ s. The temperature was set to 60° C. A homogeneous Neumann boundary condition and a random initial condition ϕ₀+r(200, 200) were applied, where ϕ₀=0.57, representing the volume fraction of DMF, and r(200, 200) was a random matrix with each entry generated from the normal distribution N(0, 10⁻⁸), representing thermal fluctuations) and, in the bottom three images, the MSPS PVDF membranes prepared at different waiting times of (d) 0.5, (e) 1, and (f) 3 min, according to one or more embodiments of the present disclosure.

FIG. 21 is a simulated pattern under a periodic initial setting and a very small noise, according to one or more embodiments of the present disclosure.

FIG. 22 is a graphical view of FT-IR spectra of the PVDF and PVDF/CA membranes made by MSPS and NIPS methods (The blue, red and black arrows point to the characteristic peaks of the α, β, γ phases of PVDF, respectively), according to one or more embodiments of the present disclosure.

FIG. 23 is a graphical view of XRD patterns of the PVDF and PVDF/CA membranes made by MSPS and NIPS methods, according to one or more embodiments of the present disclosure.

FIGS. 24A-24D are graphical views showing DSC results of membranes made by MSPS and NIPS method: (a) MSPS PVDF, crystallinity 26%; (b) NIPS PVDF, crystallinity 23%; (c) MSPS PVDF/CA, crystallinity 10%; (d) NIPS PVDF/CA, crystallinity 8%, according to one or more embodiments of the present disclosure.

FIG. 25 is a graphical view showing the stress and strain curve of the MSPS PVDF membrane, according to one or more embodiments of the present disclosure.

FIGS. 26A-26D are graphical views of: (a) pure water permeance of the MSPS PVDF and MSPS PVDF/CA membranes at different applied pressures; (b) the rejection rate of PEO molecules at different molecular weights (top axis) and molecular sizes (bottom axis) of the MSPS PVDF and MSPS PVDF/CA membranes; (c) the rejection rate of BSA and γ-globulin on the MSPS PVDF and MSPS PVDF/CA membranes; and (d) water flux in the presence of proteins BSA and γ-globulin compared to the pure water flux (The test conditions are BSA and γ-globulin concentrations of 100 ppm and an applied pressure of 0.5 bar), according to one or more embodiments of the present disclosure.

FIG. 27 a graphical view of a membrane stability test showing pure-water flux vs. time over 5 hrs (the transmembrane pressure drop was 1 bar), according to one or more embodiments of the present disclosure.

FIG. 28 is a schematic showing specifications of membrane samples for mechanical test according to ISO 527-2, according to one or more embodiments of the present disclosure.

### DETAILED DESCRIPTION

The invention of the present disclosure relates to a novel method of making highly porous membranes. The method may be referred to as mixed solvents phase separation (MSPS). In mixed solvents phase separation, one or more membrane materials may be cast in a mixed solvent. The mixed solvent may include a solvent and a non-solvent. In an embodiment, the solvent is a solvent in which one or more membrane materials can be dissolved and the non-solvent is a solvent in which one or more membrane materials cannot be dissolved. The solvent and non-solvent may form a critical solution temperature system. In particular, the solvent and non-solvent may form one or more of an upper critical solution temperature (UCST) system and a lower critical solution temperature (LCST) system. In an upper critical solution temperature system, the solvent and non-solvent are miscible (e.g., substantially miscible) at a temperature above the critical solution temperature and phase separate at a temperature below the critical solution temperature. In a lower critical solution temperature system, the solvent and non-solvent are miscible (e.g., substantially miscible) at a temperature below the critical solution temperature and phase separate at a temperature above the critical solution temperature. As described in greater detail herein, these characteristics of upper and lower critical solution temperature systems may be used to fabricate highly porous membranes according to the methods of the present disclosure.

The methods of the present disclosure are broadly and widely applicable to any polymer. The method generally only requires one or more of the following: at least one solvent and at least one non-solvent that are miscible at a first temperature and immiscible at a second temperature, and one or more membrane materials that are soluble and/or dissolve in the solvent. Accordingly, one or more of the solvent, non-solvent, and membrane material may be selected and the rest of the system may be customized based on the selection. For example, any polymer or any combination of polymers may be used to form a highly porous membrane so long as suitable solvent(s) and/or non-solvent(s) are selected. Conversely, a solvent and non-solvent pair that exhibits the properties of being miscible at a first temperature and immiscible at a second temperature may be used for any membrane material that is soluble and/or dissolves in the solvent.

In addition, other components, compositions, and/or materials may be added. For example, in some embodiments, inorganic compounds may be added to the solution. In some embodiments, the polymer(s) may be removed or extracted to form an inorganic membrane. In other embodiments, the polymer(s) may be retained to form a polymer membrane comprising inorganic compounds. The Examples described herein demonstrate the unlimited applicability of the methods of the present disclosure to a wide range of compounds to form membranes with a variety of characteristics (e.g., hydrophobic membranes, hydrophilic membranes, hydrophobic and hydrophilic membranes, etc.).

The methods of the present disclosure may further be used to make highly porous membranes with unprecedented interconnected surface and bulk porosity. Unlike conventional methods, such as temperature induced phase separation and/or non-solvent induced phase separation, which generally form a porous bulk and a dense surface layer, membranes formed according to the methods of the present disclosure may include a porous bulk and a porous surface. In this way, open pores at a surface of the membrane can not only enhance the membrane flux, but it can also enable size exclusion in nanometer scales.

### DEFINITIONS

The terms recited below have been defined as described below. All other terms and phrases in this disclosure shall be construed according to their ordinary meaning as understood by one of skill in the art.

As used herein, “contacting” refers to the act of touching, making contact, or of bringing to close or immediate proximity, including at the cellular or molecular level, for example, to bring about a physiological reaction, a chemical reaction, or a physical change (e.g., in solution, in a reaction mixture, in vitro, or in vivo). Contacting may refer to bringing two or more components in proximity, such as physically, chemically, electrically, or some combination thereof. Mixing is an example of contacting.

As used herein, “casting” refers to disposing a material on, in, or around an object or mold, among other things. For example, casting may refer to disposing a solution of a material dissolved in a solvent on an object or mold (e.g., a substrate). Casting may include, but is not limited to, one or more of depositing, pouring, dipping, coating, and applying.

As used herein, “adjusting” refers to increasing or decreasing a temperature. For example, adjusting may include manipulating an apparatus capable of heating or cooling an object, for example. Adjusting may also include exposing an object to an environment characterized by a temperature that is either higher or lower than a previous temperature.

As used herein, a “solvent” refers to any element, compound, and/or composition in which a membrane material is soluble (e.g., substantially soluble). For example, a membrane material dissolves in a solvent. Solvents generally exist in a substantially liquid phase.

As used herein, a “non-solvent” refers to any element, compound, and/or composition in which a membrane material is insoluble (e.g., substantially insoluble). For example, a membrane material does not dissolve in a non-solvent. Non-solvents generally exist in a substantially liquid phase.

As used herein, an “upper critical solution temperature system” refers to a solvent/non-solvent pair that is miscible (e.g., substantially miscible) at a temperature above an upper critical solution temperature and immiscible (e.g., substantially immiscible) at a temperature below the upper critical solution temperature.

As used herein, a “lower critical solution temperature system” refers to a solvent/non-solvent pair that is miscible (e.g., substantially miscible) at a temperature below a lower critical solution temperature and immiscible (e.g., substantially immiscible) at a temperature above the lower critical solution temperature.

As used herein, a “critical solution temperature” may refer to one or more of an upper critical solution temperature and a lower critical solution temperature.

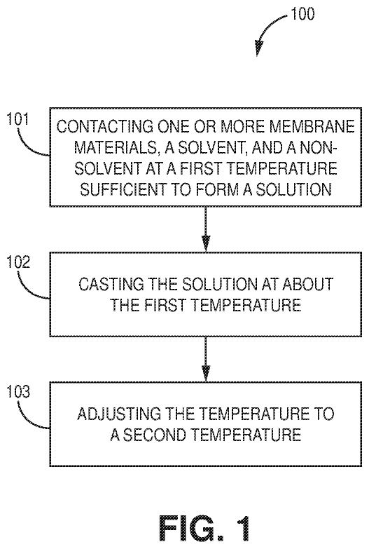

FIG. 1 is a flowchart of a method of making a porous membrane, according to one or more embodiments of the present disclosure. As shown in FIG. 1, the method 100 may include contacting 101 one or more membrane materials, a solvent, and a non-solvent at a first temperature sufficient to form a solution (e.g., a homogenous solution); casting 102 the solution (e.g., homogenous solution) at about the first temperature; and adjusting 103 the temperature to a second temperature sufficient to induce phase separation of the solvent and non-solvent and form a porous membrane. The method 100 may include an upper critical solution temperature system or a lower critical solution temperature system.

At step 101, one or more membrane materials, a solvent, and a non-solvent are contacted at a first temperature sufficient to form a solution (e.g., a homogenous solution). Contacting may include, among other things, adding the one or more membrane materials, solvent, and non-solvent into a medium sufficient to bring each of those components into close or immediate proximity For example, in some embodiments, contacting may include one or more of dissolving, stirring, and mixing. The contacting may occur over a select period of time. For example, the one or more membrane materials, solvent, and non-solvent may be contacted (e.g., dissolved and stirred) for a period of time sufficient to form a homogenous solution. As described in greater detail herein, in many embodiments, the first temperature is a temperature at which the solvent and non-solvent are miscible. In an embodiment, the first temperature is any temperature above an upper critical solution temperature. In an embodiment, the first temperature is any temperature below a lower critical solution temperature.

The one or more membrane materials may include any polymer and/or inorganic compound. For example, the one or more membrane materials include one or more of a hydrophobic polymer, a hydrophilic polymer, and an inorganic compound. In an embodiment, the one or more membrane materials include a hydrophobic polymer. In an embodiment, the one or more membrane materials include a hydrophilic polymer. In an embodiment, the one or more membrane materials include a hydrophilic polymer and a hydrophobic polymer. In any of the embodiments disclosed above and elsewhere herein, the one or more membrane materials may further include an inorganic material (e.g., an inorganic powder). For example, in an embodiment, the one or more membrane materials include a hydrophobic polymer and an inorganic compound. In an embodiment, the one or more membrane materials include a hydrophilic polymer and an inorganic compound. In an embodiment, the one or more membrane materials include a hydrophobic polymer, a hydrophilic polymer, and an inorganic compound.

In an embodiment, suitable membrane materials may include, but are not limited to, one or more of poly(amidoamine), polydimethylsiloxane, poly(etheretherketone), poly(ethylene oxide), polyethersulfone, polyimide, polymer of intrinsic microporosity, poly(4-methyl-2-pentyne), poly(1-trimethylsilyl-1-propyne), cellulose acetate, polyethylene, polypropylene, polyvinylidene fluoride, 6FDA-based polyimide, polycarbonate, and polyester. In an embodiment, suitable inorganic materials may include, but are not limited to, one or more of alpha-alumina, gamma-alumina, zirconia, nickel, copper, and stainless steel. These examples of suitable membrane materials and suitable inorganic materials shall not be limiting as any polymer and/or polymer/inorganic suspension may be used herein.

The solvent and non-solvent may include any solvent pair that exhibits upper critical solution temperature behavior and/or lower critical solution temperature behavior. In an upper critical solution temperature system, the solvent and/or non-solvent are miscible (e.g., substantially miscible, completely miscible, etc.) at a temperature above an upper critical solution temperature. The solvent and/or non-solvent are immiscible (e.g., substantially immiscible, completely immiscible, etc.) at a temperature below an upper critical solution temperature. For example, the solvent and/or non-solvent form a homogenous solution at temperatures above the upper critical solution temperature, and at temperatures below the upper critical solution temperature, the solvent and/or non-solvent phase separate. In addition, the one or more membrane materials are soluble in the solvent and/or insoluble in the non-solvent. For example, the one or more membrane materials may dissolve in the solvent, but not in the non-solvent.

In a lower critical solution temperature system, the solvent and/or non-solvent are miscible (e.g., substantially miscible, completely miscible, etc.) at a temperature below a lower critical solution temperature. The solvent and/or non-solvent are immiscible (e.g., substantially immiscible, completely immiscible, etc.) at a temperature above the lower critical solution temperature. For example, the solvent and/or non-solvent form a homogenous solution at temperatures below the lower critical solution temperature, and at temperatures above the lower critical solution temperature, the solvent and/or non-solvent phase separate. In addition, the one or more membrane materials are soluble in the solvent and/or insoluble in the non-solvent. For example, the one or more membrane materials may dissolve in the solvent, but not in the non-solvent.

The solvent may include one or more of an organic solvent, ionic liquid, and water. The non-solvent may include one or more of an organic solvent, ionic liquid, and water. The solvent and/or non-solvent may include one or more of a polar solvent and a non-polar solvent. In an embodiment, the solvent and/or non-solvent may include one or more of an alcohol, alkyl, hydrocarbon (e.g., alkane, alkene, alkyne, etc.). For example, the solvent and/or non-solvent may include one or more of methanol, ethanol, propanol, butanol, etc. In another example, the solvent and/or non-solvent may include one or more of hexane, octane, etc. In an embodiment, an upper critical solution temperature system may include an alcohol solvent mixed with an alkyl solvent. In an embodiment, a lower critical solution temperature system may include an ionic liquid.

Each of the one or more membrane materials, solvent, and non-solvent may be contacted at concentrations ranging from greater than about 0 wt. % to less than about 100 wt. %. In addition, the ratio of non-solvent to solvent may be selected and/or adjusted to control and/or tune the size of the pores of the porous membrane. In general, the pore size of the porous membrane increases as the ratio of non-solvent to solvent increases. For example, the ratio may be increased (e.g., the concentration of non-solvent may be increased relative to the concentration of solvent) to form larger pores. Conversely, the ratio may be decreased (e.g., the concentration of non-solvent may be decreased relative to the concentration of solvent) to form smaller pores. The amount of the one or more membrane materials (e.g., concentration, volume, mass, etc.) may need to be adjusted sufficient to ensure that the one or more membrane materials remain soluble and/or dissolve in the solvent. For example, in embodiments in which the weight percent of the solvent is decreased, the weight percent of the one or more membrane materials may similarly need to be decreased in order to ensure that the membrane materials dissolve in the solvent. At step 102, the solution is cast at about the first temperature. Casting generally refers to disposing a solution on a substrate, mold, or other object. In some embodiments, casting may include disposing the solution (e.g., a homogenous solution) as a thin film on a suitable substrate (e.g., glass plate). Any number of apparatuses known in the art may be used to cast the solution. For example, a doctor blade may be used. In another example, one or more of a bar-coater, slot-die-coater, blade-coater, knife-coater, roll-coater, wire-bar coater, dip-coater, and spray-coater may be used. In some embodiments, the solution may be cast in a temperature-controlled environment (e.g., closed chamber). In many embodiments, the temperature is the same as or about the same as the first temperature. In other embodiments, the temperature may or may not be the same as or about the same as the first temperature. For example, in an embodiment, the temperature is any temperature that is at least above the upper critical solution temperature. In an embodiment, the temperature is any temperature that is at least below the lower critical solution temperature.

At step 103, the temperature is adjusted to a second temperature sufficient to induce phase separation of the solvent and non-solvent and form a porous membrane. Adjusting generally refers to increasing or decreasing a temperature. For example, adjusting may include manipulating an apparatus capable of heating or cooling an object, for example. Adjusting may also include exposing an object to an environment characterized by a temperature that is either higher or lower than a previous temperature. In many embodiments, adjusting includes exposing an object to an environment characterized by a temperature that is either higher or lower than a previous temperature sufficient to cool or heat the object to a temperature either above or below a critical solution temperature. In an embodiment, adjusting may include exposing the object to an environment sufficient to cool the object below the critical solution temperature. In an embodiment, adjusting may include exposing the object to an environment sufficient to heat the object above the critical solution temperature.

In many embodiments, the second temperature is a temperature at which the solvent and non-solvent are immiscible. In this way, the solvent and non-solvent phase separate and form the porous membrane (e.g., the membrane solidifies). Accordingly, the porous membrane is formed (e.g., solidifies) when the solvent and non-solvent are immiscible. This is different from conventional methods. For example, in a conventional temperature induced phase separation process, the polymer is first dissolved in a solvent at a high temperature. The solution is then cast into a cold non-solvent solution, at which point the non-solvent replaces the solvent and the polymer is solidified via phase inversion. In order for the non-solvent to replace the solvent, the non-solvent must be miscible in the solvent. In other words, the methods of the present disclosure form the porous membrane when the solvent and non-solvent are immiscible, whereas conventional methods form a membrane when the solvent and non-solvent are miscible. Stated differently, the porous membranes of the present disclosure are formed via phase separation of the solvent and non-solvent, whereas the membranes of conventional methods are formed via phase inversion. The differences between the methods of the present disclosure and convention methods further lead to differences in membrane structure. For example, while conventional temperature induced phase separation processes may form a porous bulk, the surface is a dense layer (e.g., non-porous layer). Conversely, the mixed solvents phase separation forms a porous bulk and a porous surface layer. The presence of open pores at the surface of membranes formed according to the methods of the present disclosure not only enhances membrane flux, but it also enables size exclusion in nanometer scales.

In embodiments including an upper critical solution temperature system, adjusting may include decreasing the temperature to any temperature below the upper critical solution temperature. In these embodiments, by adjusting the temperature below the upper critical solution temperature, the solvent and non-solvent become immiscible and phase separate. Without being bound to any one theory, the phase separation may generate microdomains of solvent and non-solvent, and the one or more membrane materials may redistribute to the solvent domains. In an embodiment, a redistribution of one or more membrane materials may occur. Given that one or more membrane materials are soluble in the solvent and insoluble in the non-solvent, upon phase separating, the soluble membrane material(s) may redistribute to the solvent. In embodiments in which the one or more membrane materials include an inorganic compound, the soluble membrane material(s), including the inorganic compound, which may or may not be soluble in the solvent and/or which need not be soluble in the solvent, may redistribute to the solvent. For example, the membrane materials may be present or substantially present in the solvent. The membrane materials may be absent or substantially absent from the non-solvent.

In embodiments including a lower critical solution temperature, adjusting may include increasing the temperature to any temperature above the lower critical solution temperature. In these embodiments, by adjusting the temperature above the lower critical solution temperature, the solvent and non-solvent become immiscible and phase separate. Without being bound to any one theory, the phase separation may generate microdomains of solvent and non-solvent, and the one or more membrane materials may redistribute to the solvent domains. In an embodiment, a redistribution of one or more membrane materials may occur. Given that one or more membrane materials are soluble in the solvent and insoluble in the non-solvent, upon phase separating, the soluble membrane material(s) may redistribute to the solvent. In embodiments in which the one or more membrane materials include an inorganic compound, the soluble membrane material(s), including the inorganic compound, which may or may not be soluble in the solvent and/or which need not be soluble in the solvent, may redistribute to the solvent. For example, the membrane materials may be present or substantially present in the solvent. The membrane materials may be absent or substantially absent from the non-solvent.

The porous membrane may form after a select period of time at the adjusted temperature (e.g., second temperature). For example, the period of time during which the casted solution (e.g., homogenous solution) is at an adjusted temperature (e.g., the second temperature) or exposed to the adjusted temperature (e.g., the second temperature) may vary depending on the one or more membrane materials. In some embodiments, it can be important to optimize the period of time the casted solution is at the second temperature or exposed to the second temperature. For example, in an embodiment, overexposure or over treatment of the casted solution at the second temperature may form an unstable membrane. Accordingly, optimization of that period of time can be critical to forming a stable membrane structure. The period of time may be less than about 10 minutes, less than about 9 minutes, less than about 8 minutes, less than about 7 minutes, less than about 6 minutes, less than about 5 minutes, less than about 4 minutes, less than about 3 minutes, less than about 2 minutes, less than about 1.5 minutes, less than about 1 minute, and less than about 30 seconds. In a preferred embodiment, the period of time is between about 30 seconds and about 90 seconds. In other embodiments, the period of time may be greater than or equal to about 10 minutes.

In an embodiment, the method of making a membrane may comprise contacting one or more membrane materials, a solvent, and a non-solvent at a first temperature sufficient to form a homogenous solution, wherein the solvent and non-solvent are miscible at the first temperature; casting the homogenous solution at about the first temperature; and adjusting the temperature to a second temperature sufficient to induce phase separation of the solvent and non-solvent and form a porous membrane, wherein the solvent and non-solvent are immiscible at the second temperature.

In an embodiment, the method of making a membrane may comprise contacting one or more membrane materials, a solvent, and a non-solvent at a first temperature sufficient to form a homogenous solution, wherein the first temperature is a temperature above an upper critical solution temperature; casting the homogenous solution at about the first temperature; and adjusting the temperature to a second temperature sufficient to induce phase separation of the solvent and non-solvent and form a porous membrane, wherein the second temperature is a temperature below the upper critical solution temperature.

In an embodiment, the method of making a membrane may comprise contacting one or more membrane materials, a solvent, and a non-solvent at a first temperature sufficient to form a homogenous solution, wherein the first temperature is a temperature above a lower critical solution temperature; casting the homogenous solution at about the first temperature; and adjusting the temperature to a second temperature sufficient to induce phase separation of the solvent and non-solvent and form a porous membrane, wherein the second temperature is a temperature below the lower critical solution temperature.

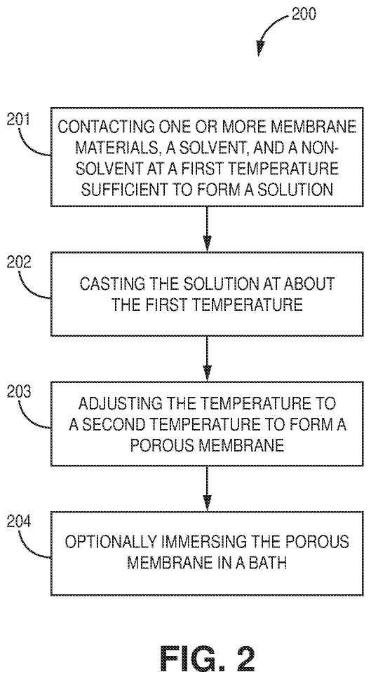

FIG. 2 is a flowchart of a method of making a porous membrane, wherein the method optionally comprises immersing the porous membrane in a bath, according to one or more embodiments of the present disclosure. As shown in FIG. 2, the method may comprise contacting 201 one or more membrane materials, a solvent, and a non-solvent at a first temperature sufficient to form a solution; casting 202 the solution at about the first temperature; adjusting 203 the temperature to a second temperature to form a porous membrane; and optionally immersing 204 the porous membrane in a bath.

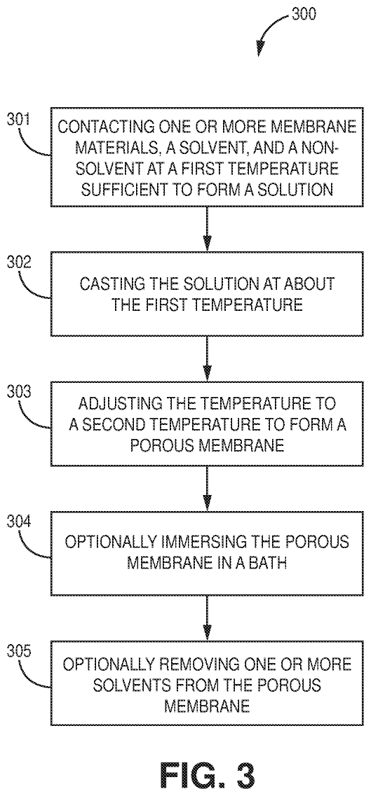

FIG. 3 is a flowchart of a method of making a porous membrane, wherein the method optionally comprises one or more of immersing the porous membrane in a bath and removing one or more solvents from the porous membrane, according to one or more embodiments of the present disclosure. As shown in FIG. 3, the method may comprise contacting 301 one or more membrane materials, a solvent, and a non-solvent at a first temperature sufficient to form a solution; casting 302 the solution at about the first temperature; adjusting 303 the temperature to a second temperature to form a porous membrane; and optionally further comprising one or more of immersing 304 the porous membrane in a bath and removing 305 one or more solvents from the porous membrane.

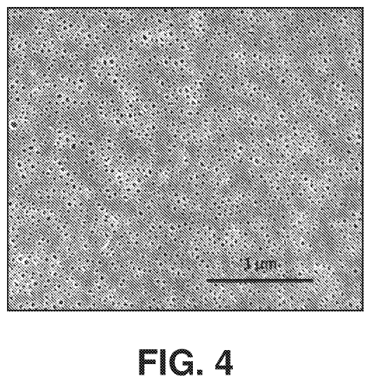

FIG. 4 is a flowchart of a method of making a porous membrane, according to one or more embodiments of the present disclosure. As shown in FIG. 4, the method comprising contacting 401 one or more of polyvinylidene fluoride (PVDF), cellulose acetate (CA), alumina powder, N-Methyl-2-pyrrolidone (NMP), polyvinyl pyrrolidone (PVP), dimethylformamide (DMF), and octane at a first temperature sufficient to form a homogeneous solution; casting 402 the homogenous solution at about the first temperature; and adjusting 403 the temperature to a second temperature sufficient to induce phase separation of the solvent and non-solvent and form a porous membrane.

At step 401, one or more of polyvinylidene fluoride (PVDF), cellulose acetate (CA), alumina powder, N-Methyl-2-pyrrolidone (NMP), polyvinyl pyrrolidone (PVP), dimethylformamide (DMF), and octane are contacted at about a first temperature to form a homogenous solution. In many embodiments, the first temperature is greater than about 75° C. In a preferred embodiment, the first temperature is about 90° C. In many embodiments, contacting includes mixing. In some embodiments, in addition or in the alternative, contacting may include stirring. For example, in an embodiment, stirring is for about 5 h.

In an embodiment, one or more of PVDF, DMF and octane may be contacted. For example, contacting includes mixing about 15.4 wt. % PVDF, 61.5 wt. % DMF, and about 23.1 wt. % octane. In an embodiment, one or more of cellulose acetate, DMF, and octane may be contacted. For example, contacting includes mixing about 14.3 wt. % cellulose acetate, 57.1 wt. % DMF, and about 28.6 wt. % octane. In an embodiment, one or more of PVDF, cellulose acetate, DMF, and octane may be contacted. For example, contacting includes mixing about 7.4 wt. % PVDF, 7.4 wt. % CA, 59.3 wt. % DMF, and 25.9 wt. % octane. In an embodiment, one or more of alumina powder, NMP, PVP, PVDF, and octane may be contacted. For example, contacting includes mixing about 48.0 wt. % alumina powder, 31.5 wt. % DMF, 11.8 wt.% octane, 0.80 wt. % PVP, 7.9 wt. % PVDF and 15.5 wt. % octane. In other embodiments, any combination of compounds may be used. At step 402, the homogenous solution is casted at about the first temperature. Any of the embodiments described herein may be used here.

At step 403, the temperature is adjusted to a second temperature sufficient to induce phase separation of the solvent and non-solvent and form a porous membrane. The second temperature may include any temperature below and/or above the critical solution temperature. In many embodiments, the second temperature is a temperature below about 75° C. In a preferred embodiment, the second temperature is about room temperature. In an embodiment, adjusting includes exposing the casted solution to ambient environment. In an embodiment, adjusting includes exposing the casted solution to ambient environment for about 1 minute. In an embodiment, adjusting includes exposing the casted solution to ambient environment for about 40 sec.

The porous membrane may be one or more of hydrophobic and hydrophilic and, in some embodiments, the porous membrane may be a porous ceramic membrane. For example, in an embodiment, the membrane may be a porous hydrophobic PVDF membrane. In an embodiment, the membrane may be a porous hydrophilic cellulose acetate membrane. In an embodiment, the membrane may be a porous PVDF/cellulose acetate composite membrane. In an embodiment, the membrane may be a porous inorganic membrane.

In some embodiments (not shown), the method 400 may further comprise immersing the porous membrane in a water bath. For example, the porous membrane may be immersed in the water bath until the film is detached.

In an embodiment, the method comprises a method of making a porous PVDF membrane. The method may comprise contacting one or more of polyvinylidene fluoride (PVDF), dimethylformamide (DMF), and octane at a temperature above about 75° C.; casting the homogenous solution at about 75° C.; and adjusting the temperature to a temperature below about 75° C. sufficient to induce phase separation of the solvent and non-solvent and form a porous membrane.

In an embodiment, the method comprises method of making a porous cellulose acetate membrane. The method may comprise contacting one or more of cellulose acetate (CA), dimethylformamide (DMF), and octane at a temperature above about 75° C.; casting the homogenous solution at about 75° C.; and adjusting the temperature to a temperature below about 75° C. sufficient to induce phase separation of the solvent and non-solvent and form a porous membrane.

In an embodiment, the method comprises a method of making a porous PVDF/cellulose acetate membrane. The method may comprise contacting one or more of polyvinylidene fluoride (PVDF), cellulose acetate (CA), dimethylformamide (DMF), and octane at a temperature above about 75° C.; casting the homogenous solution at about 75° C.; and adjusting the temperature to a temperature below about 75° C. sufficient to induce phase separation of the solvent and non-solvent and form a porous membrane.

In an embodiment, the method comprises a method of making a porous inorganic membrane. The method may comprise contacting one or more of alumina powder, N-Methyl-2-pyrrolidone (NMP), polyvinyl pyrrolidone (PVP), PVDF, and octane at a temperature above about 75° C.; casting the homogenous solution at about 75° C.; and adjusting the temperature to a temperature below about 75° C. sufficient to induce phase separation of the solvent and non-solvent and form a porous membrane.

Embodiments of the present disclosure describe a particulate matter (PM) mask. In many embodiments, the mask may be used for removing particulate matters. The mask may comprise a porous membrane. For example, the membrane may be fabricated according to any of the methods described herein. In many embodiments, a material of the membrane is one or more of polymer, metal, and ceramics. In many embodiments, the membrane includes one or more of polyvinylidene fluoride (PVDF) and cellulose acetate (CA). The membrane may be fabricated and/or assembled into a face mask.

In an embodiment, the mask may be characterized according to the particle size it is capable of removing from inhalation. For example, in an embodiment, the mask may be characterized as one or more of PM10, PM2.5, and PM0.1, wherein PM10 is characterized by particles with a diameter that is less than about 10 micrometers, wherein PM2.5 is characterized by particles with a diameter that is less than about 2.5 micrometers, wherein PM0.1 is characterized by particles with a diameter that is less than about 0.1 micrometers.

In some embodiments, the PM mask may be characterized by a pore size that ranges from about 1 nm to about 10 μm. In an embodiment, the pore size is about 100 nm. In an embodiment, the pore size is about 1 μm. In a preferred embodiment, the pore size is less than about 2.5 μm. In addition, in some embodiments, the membrane thickness is about 1 μm. In other embodiments, the membrane thickness may be greater than or less than about 1 μm, which may be varied according to the requirements of a particular application and/or environment.

Embodiments of the present disclosure describe methods of making a particulate matter mask. The particulate matter mask may be fabricated according to any of the methods described herein.

Embodiments of the present disclosure describe an air filtration system. In many embodiments, the air filtration system may comprise a porous membrane for removing one or more of PM10, PM2.5, and PM0.1. The air filtration system may comprise a porous membrane. For example, the membrane may be fabricated according to any of the methods described herein. In many embodiments, a material of the membrane is one or more of polymer, metal, and ceramics. In many embodiments, the membrane includes one or more of polyvinylidene fluoride (PVDF) and cellulose acetate (CA). The membrane may be fabricated and/or assembled into an air filtration system.

In a preferred embodiment, the air filtration system comprises a porous membrane suitable for removing both PM10 and PM2.5. In some embodiments, the air filtration system may be characterized by a pore size that ranges from about 1 nm to about 10 μm. In an embodiment, the pore size is about 100 nm. In an embodiment, the pore size is about 1 μm. In a preferred embodiment, the pore size is less than about 2.5 μm. In addition, in some embodiments, the membrane thickness is about 1 μm. In other embodiments, the membrane thickness may be greater than or less than about 1 μm, which may be varied according to the requirements of a particular application and/or environment.

Embodiments of the present disclosure describe methods of making an air filtration system. The air filtration system may be fabricated according to any of the methods described herein.

In embodiments relating to a PM mask and/or air filtration system, the following relationship may exist:

εd/τL>0.05

where the diameter of the pore size d in m, surface porosity is ε, membrane tortuosity is τ, and membrane thickness is L in m.

The following Examples are intended to illustrate the above invention and should not be construed as to narrow its scope. One skilled in the art will readily recognize that the Examiners suggest many other ways in which the invention could be practiced. It should be understand that numerous variations and modifications may be made while remaining within the scope of the invention.

### EXAMPLE 1

### Preparation of Porous PVDF Membrane

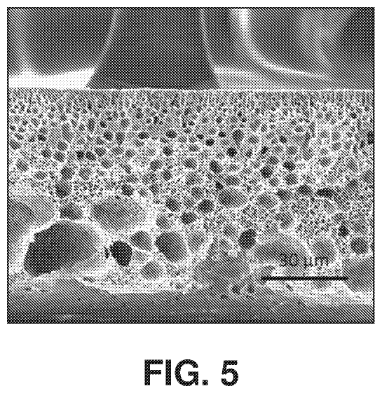

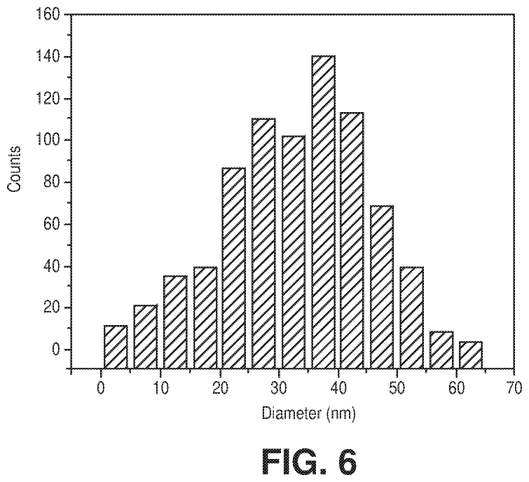

PVDF is a thermal plastic fluoropolymer, highly resistance to solvents, acid and base. It has very good thermal stability and strong mechanic strength. PVDF membranes have been widely used in membrane applications. The solvent used in this case is DMF, which is a polar solvent (dipole moment in vacuum is 3.82 D). The non-solvent is octane which is an apolar solvent. DMF and octane forms a UCST system with a critical temperature at 75.35° C. 15.38 wt % PVDF was dissolved in 61.54 wt % DMF and 23.08 wt % of octane at 90° C. by continuous stirring for 5 h. The solution was spread into a thin film on a glass plate by a doctor blade inside a closed chamber at 90° C. The film was covered by a glass petri dish and removed from the hot plate to ambient environment. After 1 minute the film was immersed in a DI water coagulation bath until it was detached. The film was taken out and kept in DI water for 24 h to remove any traces of solvents. Finally the film were washed several times with water and hexane and dried at ambient conditions for further analysis. The resultant film showed a nontransparent white color and had an average thickness of 80 μm. FIGS. 4 and 5 show the SEM images of the top surface and the cross section of the porous PVDF membrane. The top surface composed of pores in high density with pore size in tens of nanometer. The cross section shows that the bulk membrane is also highly porous. The pore size increase from the top layer to the bottom. The pore size in the top surface was counted by the Image J® software and FIG. 6 shows the statistics. The average and maximum pore diameter were found to be 35 and 63 nm respectively.

### EXAMPLE 2

### Preparation of Porous Cellulose Acetate Membrane

Cellulose acetate (CA) is another important membrane material. CA is the first commercialized RO membrane. Today it still occupies a significant market share because of its cheap price. The film casting process is similar to that of the PVDF membrane. Again, DMF is used as the solvent, and octane as non-solvent. First, 14.29 wt % CA was dissolved in 57.14 wt % DMF and 28.57 wt % of octane by continues stirring for 5 h at 90° C. The solution was cast on a glass plate inside a closed chamber at 90° C. Immediately after casting, the membrane on the glass plate was covered with a petri dish and remove it from the hot plate to ambient environment. This was left for 1 minute at RT which will allow the cast solution to cool down below the critical temperature and conduct phase separation. The cast film was then immersed in a DI water coagulation bath until the membrane were detached. The membrane was taken out and kept in DI water for 24 h for removing any traces of solvents. Finally the membrane was washed several times with isopropyl alcohol and dried under ambient conditions for further analysis. The resultant film showed a nontransparent white color and had an average thickness of 170 μm.

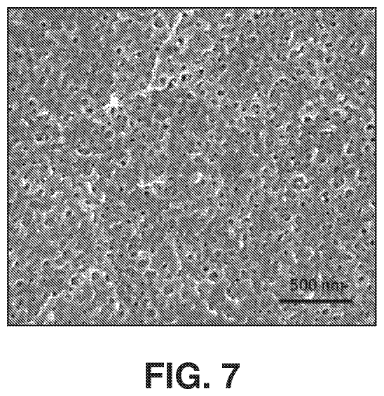

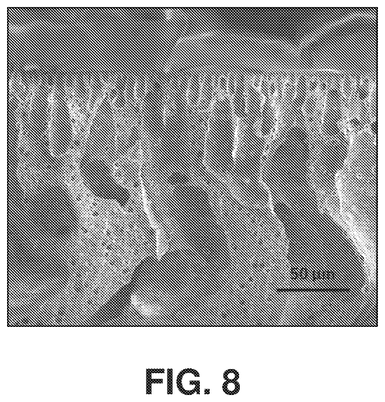

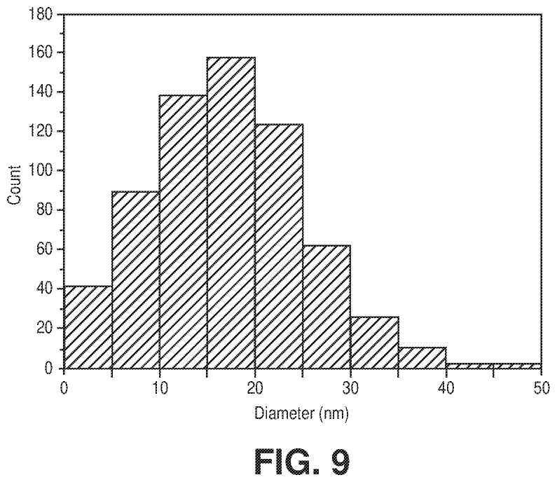

The resulting membrane porous structure is shown in FIGS. 7-9. The pore size on the surface was found smaller than that of PVDF membrane. The average and maximum pore diameter were found to be 17.5 and 47.5 nm respectively. The cross section SEM image shows that the bulk porous structure is also different from that of the PVDF. The bulk porous structure in this case is close to the common fingering-like structure.

### EXAMPLE 3

### Preparation of Porous PVDF/CA Composite Membrane

The casting solution contains 7.41 wt % PVDF, 7.41 wt % CA, 59.26 wt % DMF and 25.93 wt % octane. PVDF and CA were dissolved in DMF and octane to form a homogenous solution by continues stirring for 6 h at 90° C. The solution was cast on a glass plate inside a closed chamber at 90° C. Immediately after casting, the polymer film was covered with a petri dish and remove it from the hot plate to ambient environment. This was left for 40 second at RT which will allow the cast solution to cool down below the critical temperature to conduct phase separation. The cast film was then immersed in a DI water coagulation bath until the membrane was detached. The membrane was taken out and kept in DI water for 24 h for removing any traces of solvents. Finally the membrane was washed several times with isopropyl alcohol and dried under ambient conditions for further analysis. The resultant film showed a nontransparent white colour and had an average thickness of 90 μm.

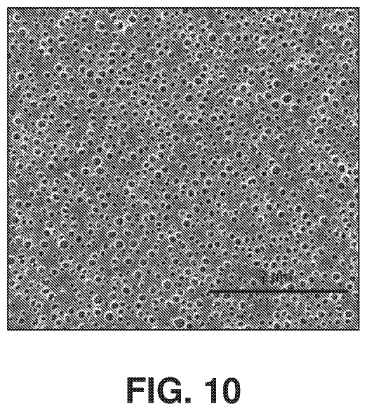

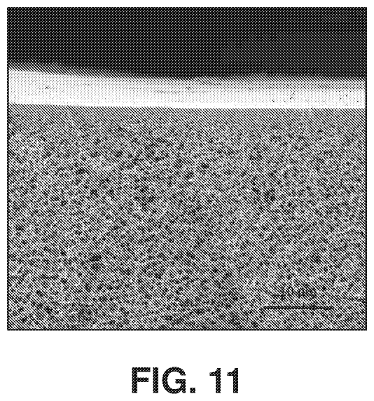

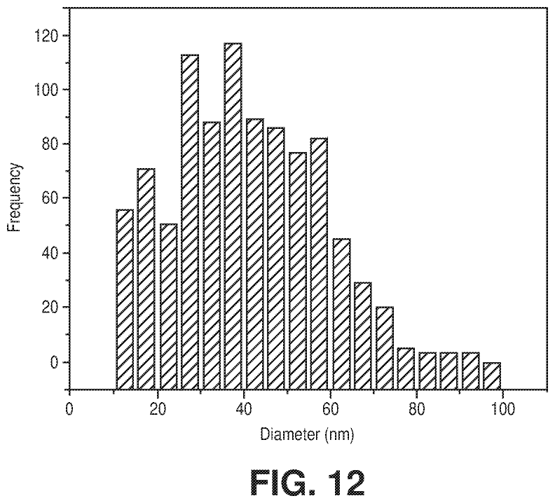

The membrane porous structure is shown in FIGS. 10-12. FIG. 10 shows the SEM image of the top surface, which shows that the top surface is composed of high density pores in tens of nanometer size. The cross section SEM image in FIG. 11 shows that bulk of the membrane contains sponge-like porous structure with high porosity. The average and maximum pore diameter estimated from software Image J® were found to be 35 and 95 nm respectively.

### EXAMPLE 4

### Preparation of Porous Inorganic Membrane

In the first step, α-alumina powder (48 wt %), DMF (31.5 wt %) and polyvinyl pyrrolidone (PVP) (0.8 wt %) were loaded into a ball mill jar. The mixture was ball milled at 400 rpm for 3 hr. Then, PVDF (7.9 wt %) was added into the jars and continue milling the mixture for another 15 hr. After milling, the suspension was transferred to a round bottom flask equipped with a mechanical stirrer. Octane (11.8 wt %) was added to the suspension. The whole mixture was heated to 90° C. and vigorously stirred for 12 hr. The solution was then cast on a glass plate inside a closed chamber at 90° C. Immediately after casting, the film was covered with a petri dish and remove it from the hot plate to ambient environment. This was left for 40 second at RT which will allow the cast solution to cool down to initiate phase separation. The cast film was then immersed in a DI water coagulation bath until the membranes were detached from the glass plate. The membranes were taken out and kept in DI water for 24 h for removing any traces of solvents. Finally the membranes were washed several times with isopropyl alcohol and sintered at 1500° C. for 2° C./min to produce highly porous ceramic membrane.

### EXAMPLE 5

### Preparation of Highly Porous Polymer Ultrafiltration Membranes Via Spinodal Decomposition of Mixed Solvents with UCST Phase Behavior

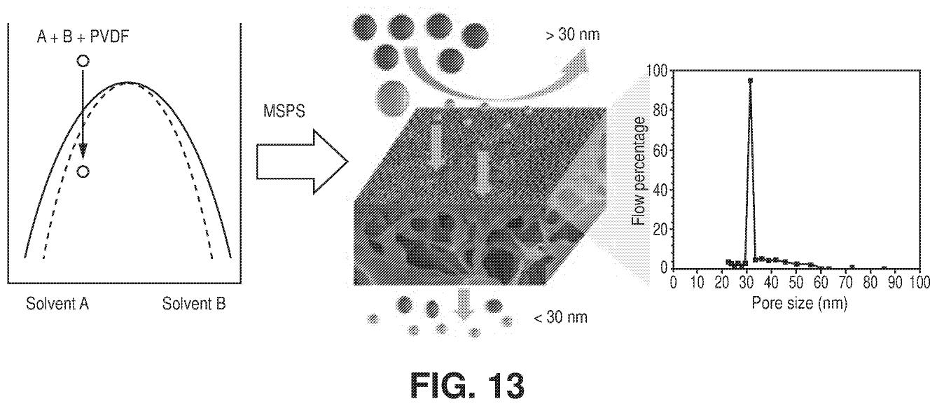

Ultrafiltration (UF) that contain pores between 2 to 100 nm is one of the most important membrane processes. The predominant method to prepare UF membranes is based on phase-inversion. However, this method always leads to a dense skin with low porosity when normal polymers are used. Using the self-assembly of certain block copolymers it is possible to prepare uniform pores with high porosity, but the prices of these polymers are too high to be afforded in practical applications. The present Example describes a novel strategy to prepare highly porous and asymmetric polymer membranes using the widely used polyvinylidene fluoride (PVDF) as a prototype. (FIG. 13) The method described herein combines spinodal decomposition with phase-inversion utilizing mixed solvents that have an unique upper critical solution temperature (UCST) phase behavior. The spinodal decomposition generates a thin surface layer containing a high density of relatively uniform pores in the mesoporous range, and the phase-inversion generates a thick bulk layer composed of macrovoids; the two types of structures are interconnected, yielding a highly permeable, selective, and mechanically strong porous membrane. The membranes show an order-of-magnitude higher water permeance than commercial membranes and efficient molecular sieving of macromolecules. Notably, the strategy provides a general toolbox to prepare highly porous membranes from normal polymers. By blending PVDF with cellulose acetate (CA), a highly porous PVDF/CA membrane was prepared and showed similarly high separation performance, but the hydrophilicity of CA improved the membrane anti-fouling performance.

The pore size of ultrafiltration (2-100 nm) is on the scale of many important species such as macromolecules, viruses, bacteria, colloidal particles, and nanoparticles. Hence, UF has found broad applications in various industrial processes such as haemodialysis, food & beverage, pharmaceutical, chemical & petrochemical, as well as in municipal water treatments. The UF market is projected to reach USD 20 billion by 2023 with an annual growth rate of 15%.

The predominant methods to prepare UF membranes include non-solvent induced phase separation (NIPS) and temperature induced phase separation (TIPS). Both methods are based on phase-inversion between a solvent, in which the polymer is soluble, and a non-solvent, in which the polymer is insoluble, which is usually water. The solvent and the non-solvent are miscible with each other, so that when the polymer/solvent solution is brought in contact with the non-solvent, the non-solvent replaces the solvent to induce phase inversion and in consequence leads to the precipitation of the polymer to generate an asymmetric membrane structure with a dense skin layer and a macroporous bulk layer in one step. The generation of the asymmetric membrane structure is one of the most important milestones in membrane development because the membrane performance is primarily determined by the structure of the skin layer, while the thick bulk layer provides enough mechanical strength. However, to the best of Applicant's knowledge, all the reported polymer membranes prepared out of normal polymers have either high porosity but large pore size (>250 nm), or low porosity (<2%) in the UF pore size range. The low porosity has greatly limited the water permeance of UF membranes, which is typically less than 100 LMH/bar. The only reported efficient way to prepare highly porous UF membranes is to use the self-assembly of block copolymers (SABCP) that contain blocks with different properties. The SABCP method can generate an almost ideal membrane structure, i.e. high porosity, uniform pore size, and thin skin. It can also combine with the phase-inversion process to prepare UF membranes in large scale. However, block copolymers are expensive and their stability is poor. Furthermore, the porous structure of block copolymer membranes is strongly dependent on many factors such as the type of polymer blocks, the total molecular weight, the ratio of the blocks, and the polydispersity. All these requirements pose significant challenges in polymer design and synthesis.

On the other hand, the widely used polymers in practical applications are normal polymers such as PVDF, CA, polysulfone (PS) and polyethersulfone (PES). These polymers have good chemical and mechanical stabilities, and their prices are cheap. However, as abovementioned the UF membranes prepared out of these polymers always have a dense skin with very low porosity. Hence, it is highly desirable to develop a new method to prepare UF membranes out of these normal polymers with the surface porous structure similar to that of the SABCP method. Here, a novel strategy is described in which spinodal decomposition is combined with phase-inversion. The strategy employs a mixed solvent system that has an upper critical solution temperature (UCST). The polymer should be soluble only in one solvent but not the other. The UCST behavior allows the mixed solvent system and the polymer to form a homogeneous solution at high temperatures; while when the temperature switches below the critical point, the mixed solvents phase separate via spinodal decomposition to generate regular nanodomains. During this process, the polymer migrates to the soluble solvent domains and becomes concentrated. The membrane is then immersed in a non-solvent bath (e.g. water), which precipitates the polymer and removes the solvents. Finally, a porous membrane with a high density of surface pores is obtained. This novel process has been named ‘mixed solvent phase separation’ (MSPS).

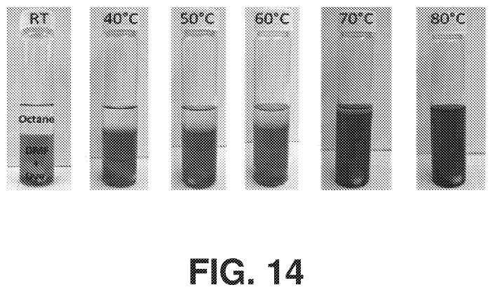

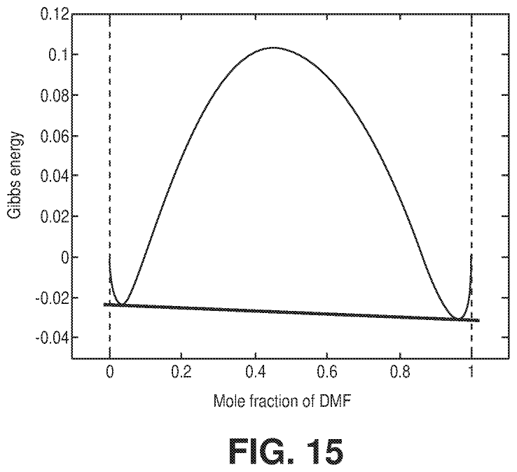

A common solvent was used for the preparation of polymer membranes, N,N-dimethylformamide (DMF), which can form UCST systems with alkanes. Most of the normal polymers were not soluble in alkanes. Hence in this study, DMF and octane were used as the prototype mixed-solvent system. The concept was demonstrated by using PVDF as the prototype polymer. However, PVDF is hydrophobic and known to be prone to fouling. Hence, PVDF was blended with cellulose acetate (CA) to use the hydrophilicity of CA to improve the anti-fouling performance and to demonstrate the adaptive capability of the method. See FIGS. 14 and 15.

### Results and Discussion

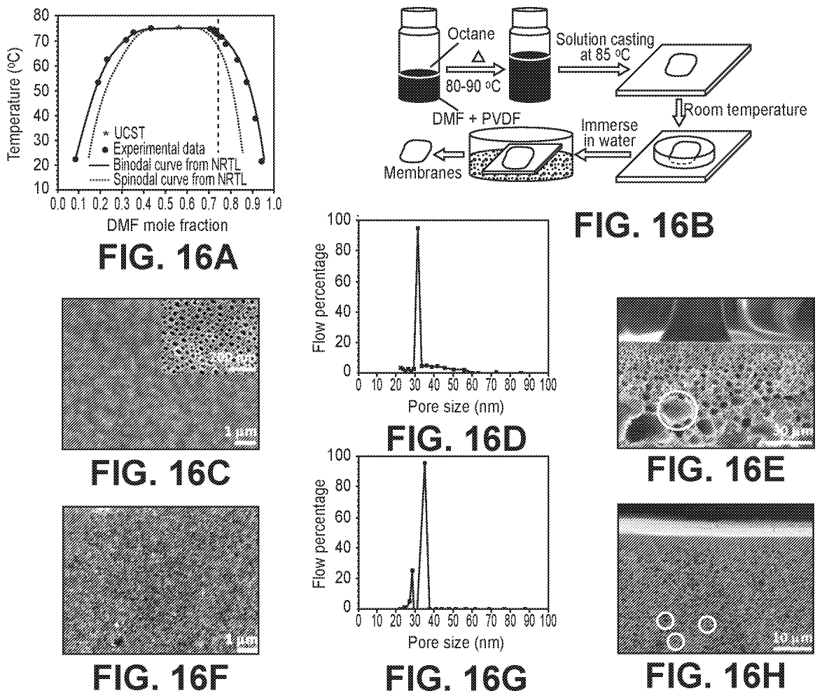

The DMF/octane phase diagram was measured by a simple titration method and shown in FIG. 16A. The phase diagram had a UCST point around 75° C. Fitting the equilibrium data points by a non-random two-liquid (NRTL) model provided the binodal curve (blue line) and the pinodal curve (red line). Based on this phase diagram, the membrane-reparation procedure illustrated in FIG. 16B was developed. First, a homogeneous solution of DMF, octane, and PVDF was formed above 85° C. The red dashed line indicates the composition of the mixed solvent in the phase diagram, where the mole fraction of DMF is 74%. The membrane was cast at 85° C. through the standard solution casting procedure. The membrane was then covered by a glass container to avoid over evaporation in the surface and left at room temperature. A certain period of time was set for waiting to allow the temperature to drop below the critical point at which phase separation initiated. In a typical process, the surface temperature dropped to 60° C. after waiting for one minute. Then, the membrane was immersed in a room-temperature water bath to form a solidified membrane.

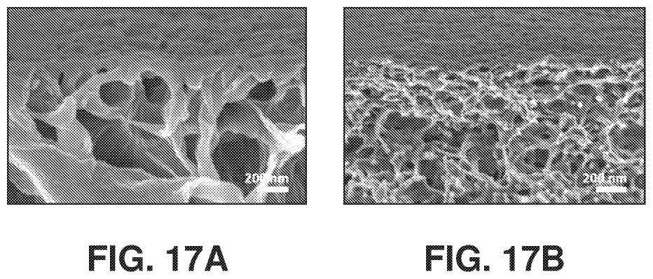

FIG. 16C shows the top-view SEM image of the PVDF membrane prepared by MSPS. The PVDF membrane contained a high density (estimated to be 2.1×10¹⁴ m⁻²) of surface pores. The surface porosity was around 21%. The pore size appeared less uniform than the SABCP membranes in the SEM images. However, the size distribution determined by the porosimetry in FIG. 16D showed a sharp distribution with an average pore size around 31±2 nm. Both the surface porosity and size uniformity were much better than the membranes prepared by the normal phase-inversion methods. A cross-sectional SEM image of the membrane is shown in FIG. 16E. The total membrane thickness was around 65±8 μm. The bulk phase had a very hierarchical porous structure, and the surface layer was very thin. A close look into the surface layer (FIGS. 17A-17B) indicated that it opened up immediately to the bulk layer. Below the surface layer, there were two types of nanostructures: coarse spherical pores and fine, sponge-like structures. The size of the spherical pores increased gradually from top to bottom, while the size of the sponge-like structure was uniform. The area highlighted by the red circle in FIG. 16E shows that the two types of structures were interconnected. The membrane made of PVDF blended with CA (denoted PVDF/CA) had a similar high density of surface pores (estimated to be 7.5×10¹³ m⁻², FIG. 16F). The pore size distribution, like that of PVDF, was narrow, although less uniform (FIG. 16G). In addition to the main peak centered at 34±3 nm, a minor peak appeared at 28±2 nm. However, the bulk structure of the PVDF/CA membrane was much more uniform. The bulk structure contained the spherical pores again, as highlighted by the circles in FIG. 16H, and the sponge-like structures, but the sizes of these two nanostructures were much closer to each other.

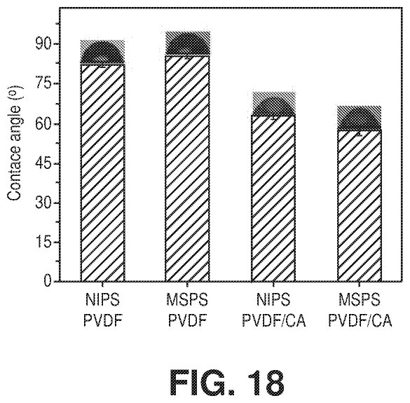

It was hypothesized that the surface pores were generated by spinodal decomposition of the mixed solvents because the surface temperature dropped quickly below the spinodal curve during the membrane-fabrication process. Because spinodal decomposition is far from thermodynamic equilibrium and has no thermal energy barrier, it was expected to occur quickly and uniformly. Hence, when octane separated from DMF, it formed local spherical domains, whereas DMF (as the major component) formed the continuous phase. PVDF migrated to the DMF phase because it is soluble in DMF only. When the membrane comes into contact with water, PVDF condensed and formed a dense skin in the DMF region. The bulk phase of the membrane was formed by two processes: phase separation between octane and DMF, and phase-inversion between DMF and water. First, octane separated from DMF and formed discrete spherical pores, and DMF and PVDF formed the continuous phase. Then, as water diffused into the bulk phase, it replaced DMF and precipitated PVDF, forming the sponge-like structure. The size of the spherical pores increased gradually from top to bottom. This was because PVDF is hydrophobic, so the diffusion of water was slow, which allowed octane at the bottom to form larger domains. In contrast, PVDF/CA was more hydrophilic (confirmed by the contact angle measurements, FIG. 18); thus, water entered very quickly, which led to a much more uniform structure.

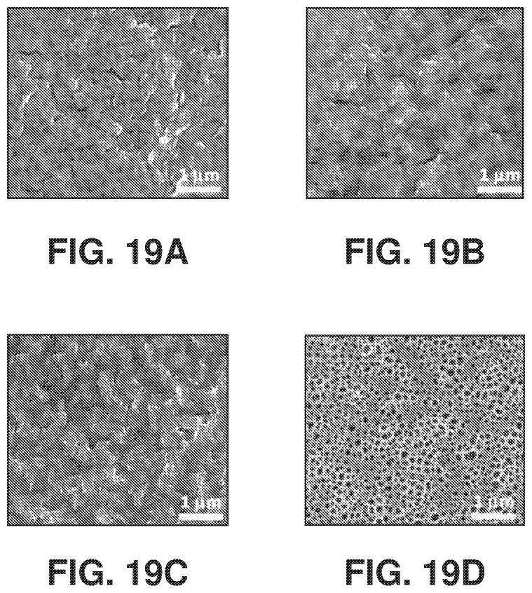

To verify the hypothesis, PVDF membranes were prepared in four different types of solvent systems following the same MSPS procedure. The first case was DMF alone (FIG. 19A), which was essentially the standard NIPS process. The second case was DMF/pyridine (FIG. 19B), where pyridine was completely miscible with both DMF and water. The third case was DMF/toluene (FIG. 19C), where toluene was completely miscible with DMF but immiscible with water. The fourth case was DMF/nonane (FIG. 19D), which was another UCST mixed solvent system with a critical temperature of around 80° C. As shown in FIGS. 19A-19D, the membranes made in the first three solvent systems were dense with very low pore densities, which were consistent with the reported PVDF membranes prepared by the standard NIPS and TIPS methods. However, the membrane made in DMF/nonane showed again a highly porous structure on the surface, similar to the DMF/octane system. Thus, it was confirmed that only a mixed solvent with the UCST phase behavior could form high density of uniform pores on the membrane surface.

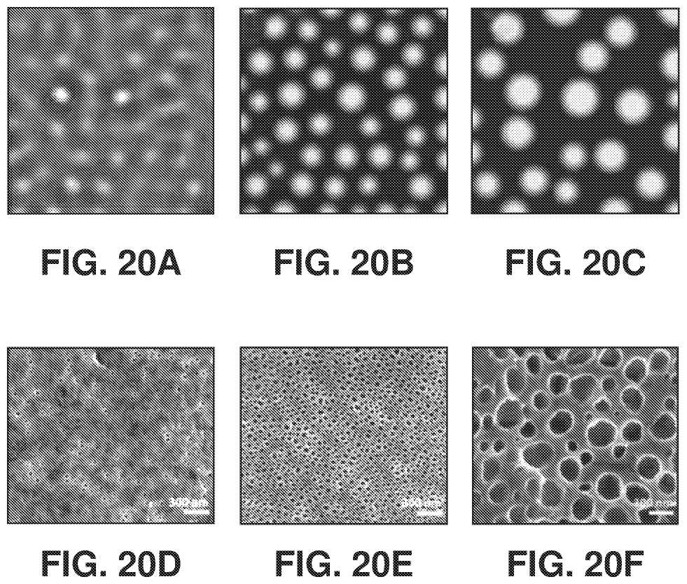

To further confirm the mechanism, the spinodal decomposition process was simulated using the Cahn-Hilliard (CH) model coupled with the Flory-Huggins free energy density. A noise term was added to the CH model to mimic disturbances due to thermal fluctuations. The simulation adopted a time step size of 3×10⁻³ s. The process was kinetically controlled, hence the pattern changed with time. FIGS. 20A-20C show the simulated patterns at different evolution steps, 10,000, 20,000, and 60,000, which correspond to the time periods of 0.5 min, 1 min and 3 min, respectively. FIGS. 20D-20F show the MSPS PVDF membranes prepared at the same time periods.

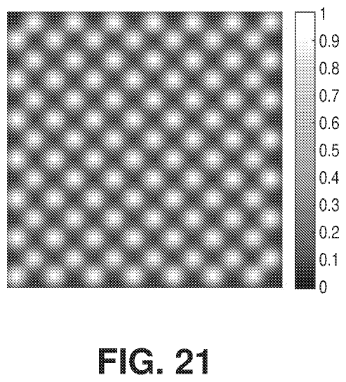

In the simulation, the phase diagram information was retrieved from FIG. 16A. However, adding polymer may have affected the phase diagram, so a strict simulation needed to consider the system as three-components. Also, due to lack of thermodynamic data for the DMF-octane system, empirical values were used for the parameters used in the NRTL model and the Flory-Huggins equation. Hence, it was expected that the simulated pattern size would be different from the experimental ones, but the structure of the pattern and the trend of its evolution with time would be similar if the pattern was formed due to spinodal decomposition of DMF and octane, which was indeed the situation by comparison between the two types of patterns. In both cases, the pores were small and the density was low at short time periods. The simulated pattern clearly indicated that the reason was because that at this stage the two solvents had not separated completely; only the centers of a few spots had sufficient intensity to generate pores. With increase in time (reaching the middle stage), the intensity of the pattern became stronger and the density increased. With further increases in time, the pattern size increased, but the density decreased. This was because the neighboring pattern domains coarsened each other, forming larger, but fewer, pores. Therefore, the simulation results confirmed that the spinodal decomposition between DMF and octane was the main mechanism for the pattern formation. The simulation results also indicated that the random noise was the source of the non-uniformity that was observed in both simulated patterns and real porous structures. When a periodic initial setting and a tiny disturbance were applied to the CH model, as shown in FIG. 21, the simulated pattern was very uniform, implying that a uniform porous structure could be obtained if all the experimental conditions were well controlled.

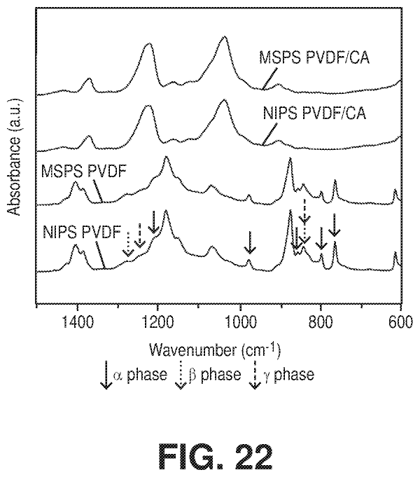

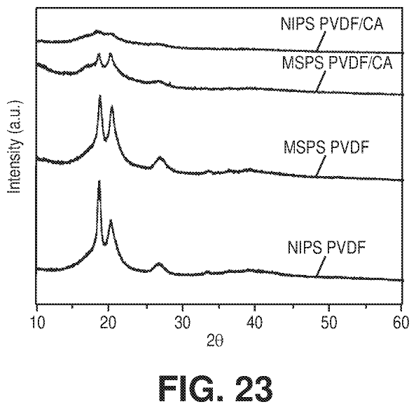

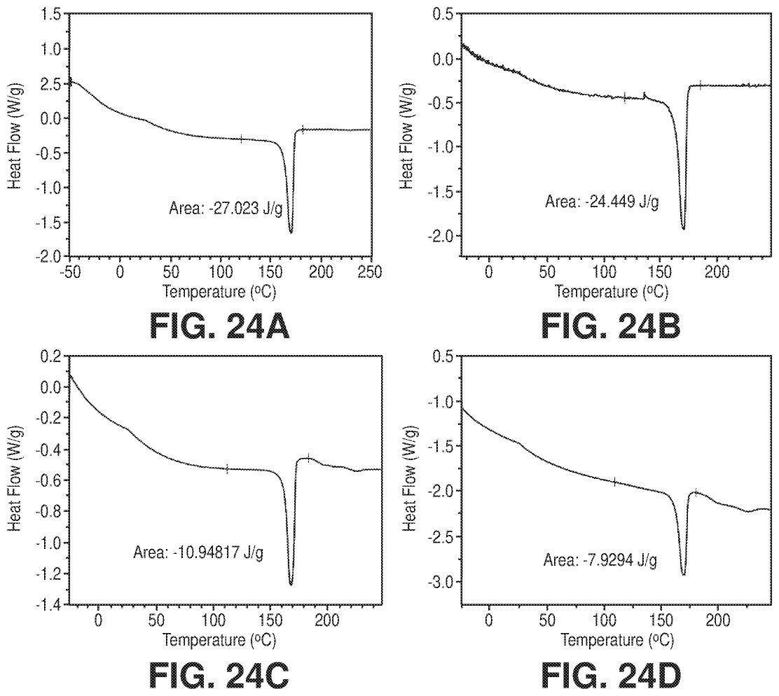

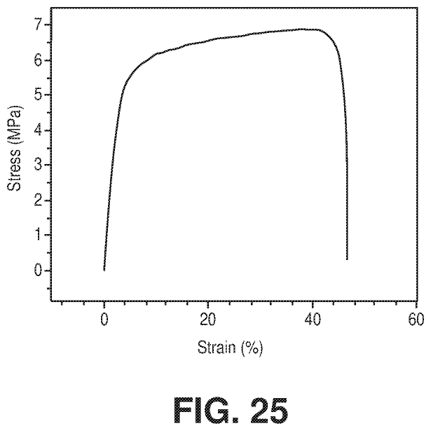

The membrane chemical structure, crystallinity and thermal properties were characterized by Fourier transform infrared spectroscopy (FTIR, FIG. 22), X-ray diffraction (XRD, FIG. 23), and differential scanning calorimetry (DSC, FIGS. 24A-24D). These results showed that the membrane properties prepared by MSPS were close to those prepared by the normal NIPS process, either prepared in this study or reported in the literature. The mechanical properties of the MSPS PVDF membrane were measured by tensile tests following the standard ISO 527-2 method (FIG. 25). A tensile strength of 6.8 MPa with a ductility of around 50% was obtained. Again, these mechanical properties were among the range of the reported PVDF membranes prepared by the NIPS method. The reason why the properties of the MSPS membranes were close to that of the NIPS membranes was probably because the temperature used in the MSPS process was low compared to the temperature used in TIPS processes (˜200° C.).

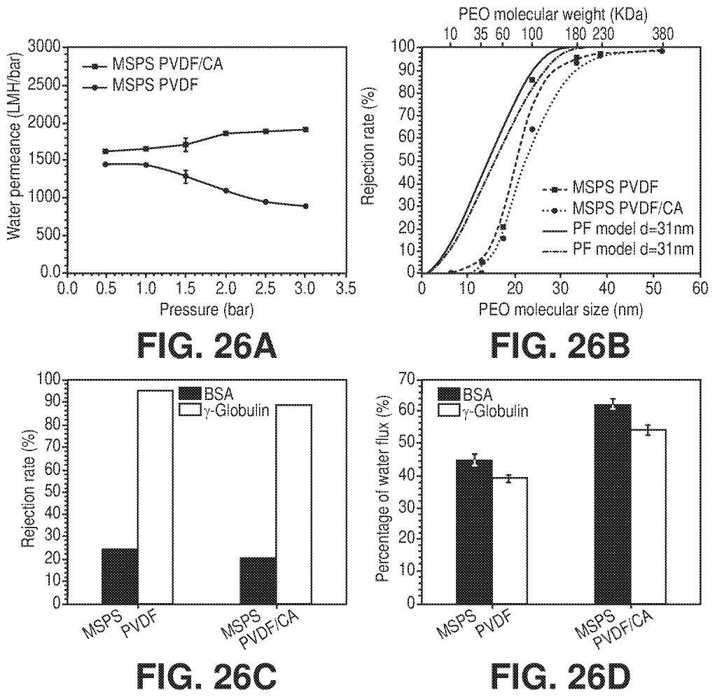

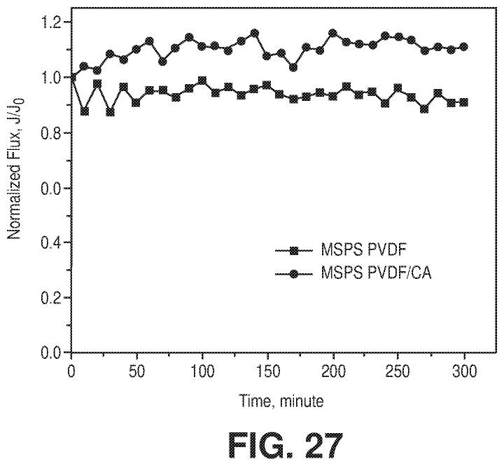

The permeation properties of the MSPS PVDF and MSPS PVDF/CA membranes are shown in FIGS. 26A-26D. The water permeances at low pressure were about 1400±45 LMH/bar for MSPS PVDF and around 1600±64 LMH/bar for MSPS PVDF/CA. The water permeance of the MSPS PVDF membrane decreased gradually to about 900 LMH/bar when the pressure was increased from 1 to 3 bar due to structure compression. The water permeance of MSPS PVDF/CA was much more stable. It even slightly increased with increases in pressure. This was most likely due to the much more uniform bulk structure. A long-term testing result is shown in FIG. 27, which shows that the water permeances of both MSPS PVDF and MSPS PVDF/CA membranes were very stable over the entire 5-h period. The effective membrane thickness was calculated using the Hagen-Poiseuille equation, which yielded 1.4 μm for the MSPS PVDF membrane and 0.73 μm for the MSPS PVDF/CA membrane. The effective membrane thickness was less than 2% of the real membrane thickness, clearly indicating the advantage of the asymmetric membrane structure.

FIG. 26B shows the size exclusion of the MSPS membranes using different molecular weights of polyethylene oxide (PEO) as the probe molecules. The molecular size of PEO was estimated using the Stokes-Einstein equation. Both MSPS PVDF and MSPS PVDF/CA membranes allowed almost all PEO molecules with a size less than 14 nm to pass through. The molecular size cut-off of the membranes was defined as a rejection rate of 90%, which, determined from FIG. 26B, was about 29 nm for MSPS PVDF and 33 nm for MSPS PVDF/CA. The molecular size cut-off of both membranes was consistent with the average pore size measured by the gas-liquid displacement porosimetry. In FIG. 26B, the rejection rates predicted by the pore-flow (PF) model assuming a uniform pore size equal to the average pore size of the membranes are shown in solid lines. The predicted transition ranges in both cases moved to a lower size range compared to the real situations, which was probably because the model was based on rigid membrane structures and rigid particles, while in real situations both the membrane and PEO molecules would be flexible. However, the shape, as well as the width of the transition ranges, of the MSPS membranes were similar to the model predictions, which indicated a sharp size exclusion effect.

An important application of ultrafiltration is protein separation. This is shown in FIG. 26C. The MSPS PVDF and MSPS PVDF/CA membranes rejected about 90% of the large γ-globulin protein but only 20% of the smaller bovine serum albumin (BSA) protein. One disadvantage of the PVDF membrane in protein separation is that it is prone to fouling because of its high hydrophobicity. As shown in FIG. 26D, in the presence of BSA and γ-globulin, the water flux dropped to about 40% of the pure water flux. An effective approach to mitigate fouling is to increase the hydrophilicity. Because blending CA with PVDF increased the hydrophilicity of the membrane, under the same conditions, the water flux of the MSPS PVDF/CA membrane was improved to about 60% of the pure water flux.

To compare the membrane performance, the best reference was SABCP membranes because they represented the state-of-art performance. The first five entries of Table 1 list the reported block-copolymer membranes with pore sizes similar to those of the MSPS membranes. The MSPS PVDF and MSPS PVDF/CA membranes had similar pore densities or porosities and water permeances as these block-copolymer membranes. Table 1 also lists a recently reported high-flux membrane made by a novel crystallization and diffusion (CCD) procedure (Entry 6). Again, the permeance was equivalent to those of MSPS membranes. The rest of the membranes listed in Table 1 are commercial UF membranes with similar pore sizes, which are prepared by either the standard NIPS or TIPS methods, and the PVDF and PVDF/CA membranes prepared by the NIPS and MSPS process in this study. All the commercial membranes and the NIPS PVDF membrane have permeances an order magnitude lower than the MSPS membranes, which clearly demonstrated the advantage of the MSPS method.

TABLE 1
Performance comparison with membranes made of block-
copolymers and with membranes commercial with similar pore sizes.

| | | | Average | Pore | Pure water |
|---|---|---|---|---|---|
| | | Method or | pore | density or | permeance |
| Entry | Membranes | manufacturer | size (nm) | Porosity | (LMH/Bar) |
| 1 | PS₁₃₈-b-P4VP₄₁ | SABCP | 30 | 2.3 × 10¹⁴ | 890 |
| 2 | PS₁₇₅-b-P4VP₆₅ | SABCP | 34 | 2.2 × 10¹⁴ | 3,200 |
| 3 | PS₁₃₈-b-PEO₁₈ | SABCP | 40 | 3.2 × 10¹⁴ | 800 |
| 4 | PS₈₁-b-P4VP₁₉ | SABCP | 34 ± 4 | 25.8% | 400 |
| 5 | PS₇₄-b-P4VP₂₆ | SABCP | 38 | 2.47 × 10¹⁴ | 625 |
| 6 | PVDF-PEG | CCD | 38 ± 2 | | 1,384 |
| 7 | PCN3CP04700 | Track-etching | 30 | 0.4% | 211 |
| 8 | IntgraFlux™ | Dow Corp. | 30 | | 40~120 |
| 9 | EnviQ® | QUA Corp. | 40 | | 20 |
| 10 | PURON® | Koch Com. | 30 | | 100 |
| 11 | PV200 | Nanostone Corp. | 45 | | 153 |
| 12 | PVDF | NIPS | 30 | | <10 |
| 13 | PVDF | MSPS | 31 ± 2 | 2.1 × 10¹⁴, 21% | 1,400 |
| 14 | PVDF-CA | MSPS | 34 ± 3 | 7.5 × 10¹³ | 1,600 |

### Conclusion

A MSPS process was successfully developed which utilized the unique UCST mixed solvent behavior to combine spinodal decomposition with phase-inversion to prepare asymmetric polymer membranes with an ultrathin surface layer containing high density of narrowly distributed pores and a thick bulk layer composed of macrovoids in one step. The MSPS PVDF membranes had a pore size around 31 nm, pore density of 2.1×10¹⁴, surface porosity of 21% and water permeance of 1400 LMH/bar, and the MSPS PVDF/CA membranes had a pore size around 34 nm, pore density of 7.5×10¹³ and water permeance of 1600 LMH/bar. Although the pore size was less uniform than the SABCP method, both membranes showed good size exclusion for separation of macromolecules and proteins, indicating that the pore size uniformity was satisfactory for practical applications. The MSPS PVDF/CA membranes showed better anti-fouling performance because of their higher hydrophilicity compared to the PVDF membranes. The pore size, surface porosity, and the permeation performance of the MSPS membranes were all equivalent to those of SABCP membranes, but order of magnitude higher than conventional membranes. Compared to the SABCP method, the MSPS method shifted the self-assembly from the polymer to the solvent; hence, any conventional polymer could be used in principle. The MSPS procedure was similar to the widely used temperature-induced phase-separation (TIPS) technique and, thus, can be scaled-up easily.

### SUPPLEMENTAL INFORMATION

Materials. Polyvinylidene fluoride (PVDF) was purchased from 3M (Dyneon™ PVDF 6133). Cellulose acetate (CA) was purchased from Eastman (CA-398-30). N,N-dimethyl formamide (DMF, >99.8), octane (>99%), nonane (>99%) and isopropyl alcohol (IPA, >99%) were purchased from Fisher Scientific. Bovine albumin serum (BSA), γ-globulin and phosphate-buffered saline were acquired from Sigma-Aldrich. Polyethylene oxide (PEO) with different molecular weights (10K, 35K, 60K, 100K, 180K, 230K and 380K) were purchased from Polymer Source, Inc. All reagents and chemicals were analytical grade and used as received. Deionized (DI) water was purified by a Milli-Q system (Millipore, Inc.).

Phase Diagram. The phase equilibrium was determined visually by observing the cloud points through a simple titration method. For the DMF/octane system, a known amount of DMF in a flask was placed in an isothermal bath with temperature accuracy of 0.1° C., and then titrated with octane. The amount of octane required to bring the onset of the next turbidity point was measured with a precision of 0.01 g. The molar fraction and the temperature at each turbidity point represented a phase equilibrium point. The molar fractions of the equilibrium points at different temperatures of the DMF/octane system are listed in Table S1.

The non-random two-liquid (NRTL) model was used to correlate the experimental liquid-liquid equilibrium (LLE) data. The NRTL correlated the activity coefficients γᵢ of a compound i with its mole fraction xᵢ in the liquid phase considered. For a binary mixture, the NRTL model was expressed as below,

$$\begin{matrix}ln {γ}_{1} = {x}_{2}^{2} [ {{τ}_{21} ( \frac{{G}_{21}}{{x}_{1} + {x}_{2} {G}_{21}} )}^{2} + \frac{{τ}_{12} {G}_{12}}{{( {x}_{2} + {x}_{1} {G}_{12} )}^{2}} ] & ( S1 ) \\ ln {γ}_{2} = {x}_{1}^{2} [ {{τ}_{12} ( \frac{{G}_{12}}{{x}_{2} + {x}_{1} {G}_{12}} )}^{2} + \frac{{τ}_{21} {G}_{21}}{{( {x}_{1} + {x}_{2} {G}_{21} )}^{2}} ] \\ where , & ( S2 ) \\ ln {G}_{12} = - {α}_{12} {τ}_{12} & ( S3 ) \\ ln {G}_{21} = - {α}_{21} {τ}_{21} & ( S4 )\end{matrix}$$

Herein α₁₂ and α₂₁ are the so-called non-randomness parameters, which are often set equally, i.e., α₁₂=α₂₁. τ₁₂ and τ₂₁ dimensionless binary interaction parameters were given by,

$$\begin{matrix}{τ}_{12} = \frac{Δ {g}_{12}}{R T} & ( S5 ) \\ {τ}_{21} = \frac{Δ {g}_{21}}{R T} & ( S6 )\end{matrix}$$

where R is the gas constant and T stands for temperature, and temperature dependent Δg₁₂ and Δg₂₁ were given by,

Δg₁₂=A₁₂+B₁₂(T_{c}−T)+C₁₂(T_{c}−T)²+D₁₂(T_{c}−T)³ (S7)

Δg₂₁=A₂₁+B₂₁(T_{c}−T)+C₁₂₁(T_{c}−T)²+D₂₁(T_{c}−T)³ (S8)

In this study, an empirical value for α₁₂=α₂₁=0.4 was set. Given the phase equilibrium data in Table S1, the coefficients in equations (S7) and (S8) were determined by the Marquardt method iteratively to fulfill the following liquid-liquid equilibrium relationship,

x₁^{α}γ₁^{α}=x₁^{β}γ₁^{β} (S9)

x₂^{α}γ₂^{α}=x₂^{β}γ₂^{β} (S10)

and mass balance relationship,

x₁^{α}+x₂^{α}=1 (S11)

x₁^{β}+x₂^{β}=1 (S12)

The coefficients for the DMF/octane system were obtained as listed below,

A₁₂=4.89552×10³ J mol⁻¹ B₁₂=9.68544×10¹ J mol⁻¹ K⁻¹

C₁₂=−2.60967×10⁰ J mol⁻¹ K⁻² D₁₂=2.74533×10⁻² J mol⁻¹ K⁻³

A₂₁=4.32912×10³ J mol⁻¹ B₂₁=4.60933×10¹ J mol⁻¹ K⁻¹

C₂₁=−4.16817×10⁻¹ J mol⁻¹ K⁻² D₁₂=1.17733×10⁻² J mol⁻¹ K⁻³

The spinodal curve was the solution of the following equation,

$$\frac{{\partial }^{2} {g}^{M} ( {x}_{1} , T )}{\partial {x}_{1}^{2}} = 0 \qquad ( S13 )$$

where g^{M} is the molar Gibbs free energy of the mixture.

Membrane Preparation. The MSPS PVDF membrane was prepared by mixing 15 wt % PVDF in 55 wt % DMF and 30 wt % of octane at 85° C. to form a homogeneous casting solution. A thin film was cast on a glass plate by a doctor blade with 200 μm air gap inside a hot chamber at 85° C. The film was covered by a glass container and left at room temperature. The surface temperature was monitored by an IR thermometer. After one minute waiting, the membrane was immersed in a room temperature DI water coagulation bath until it was detached. The membrane was then taken out and kept in another fresh DI water for 24 h to remove any trace of solvent. The preparation of the MSPS PVDF/CA membranes was similar, except that the casting solution contained 7.41 wt % PVDF, 7.41 wt % CA, 59.26 wt % DMF and 25.93 wt % octane, and the casting temperature was 90° C. For comparison, PVDF and PVDF/CA membranes were also prepared by the NIPS process in which DMF was used as a single solvent. In the standard NIPS process, the membrane was cast all at room temperature. However, for better comparison the same temperature process as the MSPS process was followed to prepare the membranes. It was found the membranes prepared by these two NIPS processes had almost the same membrane structure and physical properties. The reason was probably because the temperature used in the MSPS process was quite low compared to the normal TIPS processes (˜200° C.).

### Membrane Characterization

Field Emission Scanning Electron Microscopy (FESEM). The membrane structure was observed by FESEM. The dried membrane samples were fixed on a SEM sample holder by a double-sided carbon tape, sputtered with iridium for 60 s at 5 mA current in an argon atmosphere. The samples were then moved to the SEM stage and imaged by a Nova Nano FESEM at an accelerating voltage of 3 kV with various magnifications.

Contact Angle Measurement. The hydrophilicity of the membranes was characterized by water contact angle, measured by a contact angle goniometer (FM40, Kruss GmbH, Germany) equipped with a video recorder (Stingray model, Allied Vision Technology, USA). For static and dynamic contact angle measurements, 2 μl of DI water was dropped onto the membrane surface and the sessile drop method was applied to obtain the contact angle values. Images of the water droplets were captured using a video camera. To minimize the experimental error, the contact angle was measured at least at four random locations of the membrane and the average values were then reported. The results are shown in FIG. 18.

Fourier Transform Infrared Spectroscopy (FTIR). FTIR was measured by a Nicolet iS10 smart FTIR spectrometer (Thermo Scientific, USA) equipped with a smart OMNI transmission ranging from 400 cm⁻¹ to 4000 cm⁻¹. The results are shown in FIG. 22.

X-ray Diffraction (XRD). Wide angle XRD was performed to identify the phase composition and crystallinity of the film. XRD patterns of MSPS and NIPS membranes were recorded using Cu Kα radiation of wavelength λ=1.5406 Å with a graphite monochromator produced by Bruker AXS D8 focus advanced X-ray diffractometer operated at 40 kV and 40 mA. Before measurement, the equipment was calibrated by a standard silicon sample (Rigaku, Japan, Tokyo) with Ni-filtered. The results are shown in FIG. 23.

Differential Scanning calorimetry (DSC). The thermal behavior of the membrane samples was characterized by a DSC device (Q-2000, TA Instruments) and was used to determine the degree of crystallinity of PVDF made from the NIPS or MSPS method. The samples were heated from −25° C. to 250° C. at 10° C./min. The degree of crystallinity was calculated by the equation shown below.

$$\% Crystallinity = \frac{Δ {H}_{m}}{Δ {H}_{{m}^{o}}} \times 1 \; 00 \% \qquad ( S14 )$$

Where ΔHₘ is the heat associated with melting (fusion) of the sample and obtained from the DSC thermogram; ΔHₘ° is the heat of melting if the polymer is 100% crystalline, which was 104.7 J/g for the PVDF polymer. The results are shown in FIGS. 24A-24D.

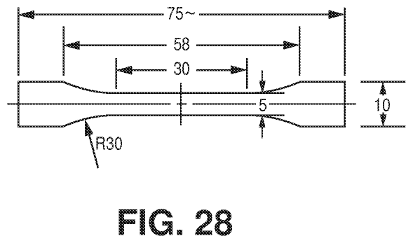

Mechanical Test. Mechanical properties of the membranes were tested according to International Organization for Standardization (ISO) 527-2, using a tensile testing machine, Instron 5882. The membrane samples were cut into the standard dog-bone shape with dimensions shown in FIG. 28 using a super dumbbell cutter. The sample thickness was measured by a micrometer (Mitutoyo USA). The samples were fixed at a gauge length of 30 mm and then stretched at a constant rate of 10 mm/min. The corresponding tensile force and elongation were recorded until breaking. At least five samples were tested for each type of membranes. A typical stress-strain curve of the PVDF membranes is shown in FIGS. 25, 28.

Pore Size Distribution Measurement. The membrane pore size distribution was measured by gas-liquid displacement porosimetry using a POROLUX 1000 device (POROMETER, Belgium). The membranes were cut into a certain size and wetted with a special wetting liquid, POREFIL, which was provided by the supplier and had a surface tension of 16 mN/m. After loading the samples into the porometer, N₂ gas was applied from one side of the membrane sample and the pressure was increased from 0 to 34.5 bar step-by-step to replace the wetting liquid inside the membrane pores. The data were recorded when both the pressure and the flow rate were stabilized within ±1% accuracy for 2 s at each step. Young-Laplace equation was employed to calculate the pore size corresponding to each operation pressure as follows.

$$d = \frac{4 γcosθ}{Δ P} \qquad ( S15 )$$

where d is the diameter of the pores which contribute to the gas flow at each operation pressure ΔP; γ is the surface tension of the wetting liquid, which is 16 mN/m; θ is the contact angle of the wetting liquid on the membrane surface, which is 0°.

Effective Membrane Thickness. The effective membrane thickness was calculated by Hagen-Poiseuille equation as follows

$$L = \frac{{nd}^{4} π Δ p}{3.56 \times 1 {0}^{- 5} η V} \qquad ( S16 )$$

Where L is the effective thickness (m) (length of the pore), n is the areal pore density (2.1×10¹⁴ for MSPS PVDF), d is the hydraulic pore diameter (m), Δp is the hydrostatic pressure drop (Pa), η is the water viscosity (8.9×10⁻⁴ Pa s at 25° C.) and V is the volumetric flow rate (LMH).

Flux and Retention Measurement. The pure water flux was tested by a homemade ultrafiltration permeation cell operated in the dead-end mode. A membrane with effective surface area of 2.3 cm² was placed first over a nonwoven fabric support and then a porous stainless steel support and sealed by O-ring. The feed side of the cell was pressurized by N₂ gas from a cylinder. The permeate water was collected and measured by a digital balance. The water permeance was calculated as follows.

$$P = \frac{V}{A \times T \times Δ p} \qquad ( S17 )$$

where, V is the volume of collected DI water during the permeation time t; A is the effective membrane area and Δp is the transmembrane pressure drop. The permeance P is reported as litre per m² per hour per bar (LMH/bar).

The molecular weight cut-off was measured using PEO with different molecular weight as probe molecules. The molecular size of PEO was estimated by the following Stokes-Einstein relationship.⁵

$$\begin{matrix}{d}_{H} = \frac{{K}_{B} T}{3 π μ {D}_{0}} & ( S18 ) \\ {D}_{0} = 1.79 \times 1 {0}^{- 4} \times {M}_{W}^{- 0.587} & ( S19 )\end{matrix}$$

Where, d_{H} is the hydrodynamic diameter of the molecule (nm); K_{B} is the Boltzmann's constant; T is the temperature (K); μ is pure solvent viscosity (Pa·s); D₀ is the diffusion constant (cm² s⁻¹) and Mw is the molecular weight (g/mol). PEO was dissolved in DI water at a concentration of 100 ppm, and then filtered through the membranes at 0.5 bar using the same ultrafiltration cell in the flux measurements at the dead-end mode. The feed and the permeate concentrations were measured by gel permeation chromatography (Agilent 1200 series system) using DI water as an eluent. The rejection rate (R, %) of the membrane for each PEO was calculated by the following equation,

$$R ( \% ) = ( 1 - \frac{{c}_{p}}{{c}_{f}} ) \times 100 \qquad ( S20 )$$

where Cₚ and C_{f} are the concentrations at the permeate and feed solutions, respectively.

The membrane capability to separate different proteins was demonstrated using two common proteins, bovine albumin (BSA) and γ-globulin (IgG). 100 ppm of BSA and IgG solutions stabilized by a commercial PBS buffer solution (phosphate buffered saline, at the physiological pH of 7.4) were used as feed solutions and filtered through the membranes at 0.5 bar in the same way as the PEO rejection measurements. The concentrations of the proteins at both feed and permeate were measured by an UV-visible spectrophotometer (Varian Cary 5000) at λₘₐₓ=280 nm. The rejection rate of each protein was calculated also by equation (S20).

For the membrane stability testing, Amicon® 8010 cell with a reservoir of 10 L DI water was used. A membrane with effective surface area of 4.1 cm² was adopted and the feed side of the cell was pressurized at 1.0 bar. The initial flux was taken after 5 minutes of pressurization.

Pore-Flow Model. The Ferry-Renkin equation as below was adopted for the calculation of theoretical rejection rate of ultrafiltration membrane. It was assumed that the pore was of the straight channel.

$$Rejction rate = [ 1 - 2 {( 1 - \frac{{d}_{p}}{d} )}^{2} + {( 1 - \frac{{d}_{p}}{d} )}^{4} ] \times 1 \; 00 \% \qquad ( S21 )$$

Where dₚ is the diameter of a solute (m); d is the pore size of a pore (m). Based on equations (S18), (S19) and (S21), the rejection curves were acquired as shown in FIG. 26B.

Simulation of Spinodal Decomposition. The total Helmholtz free energy of the mixed solvent system, F, was modelled by the Flory-Huggins equation, as shown below,

$$\begin{matrix}F = \frac{{v}_{A} {α}^{2} RT}{36} κ ( {φ}_{A} ) {\vert ∇ {φ}_{A} \vert}^{2} + \frac{1}{{rv}_{A}} ( {φ}_{A} ln {φ}_{A} + ( 1 - {φ}_{A} ) ln ( 1 - {φ}_{A} ) ) + {χφ}_{A} ( 1 - {φ}_{A} ) & ( S22 ) \\ χ = B + CT + DT ln T & ( S23 )\end{matrix}$$

Where ϕ_{A} is the local volume fraction of component A, ν_{A} is the molecular volume of component A, α is the Kuhn segment length,⁷ κ(ϕ_{A}) is the gradient energy coefficient that is obtained by the random phase approximation (RPA), r is the molecular volume ratio of the two solvent components, χ is the interaction parameter, and R and T are gas constant and temperature respectively. B, C and D are constants.

The spinodal decomposition was modeled by the following Cahn-Hilliard equations with a white noise term.

$$\begin{matrix}\frac{\partial {φ}_{A}}{\partial T} = η Δ μ + ξ ( x , t ) & ( S24 ) \\ μ = \frac{δ G}{δ {φ}_{A}} & ( S25 )\end{matrix}$$

Where, η is the chemical mobility (assumed to be composition independent), and ξ represents a random noise term.

Combining with the Flory-Huggins equation and let

$$M = \frac{η R T}{r {v}_{A}} , {ϵ}^{2} = \frac{{v}_{A}^{2} {α}^{2} r R T}{36}$$

and φ=rχν_{A}, the model equations were written as,

$$\begin{matrix} \frac{\partial {φ}_{A}}{\partial T} = M Δ μ + ξ ( x , t ) & ( S26 ) \\ μ = - 2 {ϵ}^{2} ∇ \cdot ( κ ( {φ}_{A} ) ∇ {φ}_{A} ) + {ϵ}^{2} {κ}^{′} ( {φ}_{A} ) {\vert ∇ {φ}_{A} \vert}^{2} + ln \frac{{φ}_{A}}{1 - {φ}_{A}} + ϕ ( 1 - 2 {φ}_{A} ) & ( S27 )\end{matrix}$$

The model was solved numerically by combining the scalar auxiliary variable (SAV) method with the mixed finite element (MFE) method. The SAV method was used first to generate time-discrete spatially continuous system of partial differential equations (PDEs) from the model. The mixed finite element (MFE) method was then used to discretize the above resultant steady-state PDEs. MFE guaranteed local mass-conservation and accordingly preserved the mass-conservation globally. Consequently, the numerical method based on SAV for the time variable and MFE for the spatial variables were energy-decaying and locally mass conservative. In other words, the employed numerical method was physics-preserving, and satisfied the conservation law of mass and the second law of thermodynamics.

The numerical simulation was implemented in a two-dimensional square and the domain size was 1000 nm×1000 nm which was divided into 200×200 sub-squares with uniform size of 5 nm×5 nm. The simulation gave the space distribution of the two solvents, which mimicked the nano-pattern that was generated by the spinodal decomposition process. A random noise term ξ(x, t) was used in a normal simulation, which was given by ϕ₀+r(200,200), where ϕ₀=0.57 representing the volume fraction of DMF, and r(200, 200) was a random matrix with each entry generated from the norm distribution N(0, 10⁻⁸) representing thermal fluctuations. In an ideal case when the initial setting was periodic and a very small random noise was adopted, which was given by the normal distribution of N(0, 10⁻¹⁰), a uniform pattern was obtained, as shown in FIG. 21.

TABLE S1
Experimental LLE Data

| Temperature | Molar Fraction of DMF |
|---|---|
| 21.8 | 0.94074 |
| 39.0 | 0.91484 |
| 53.5 | 0.87395 |
| 62.5 | 0.82797 |
| 69.0 | 0.77568 |
| 71.5 | 0.75413 |
| 72.8 | 0.73381 |
| 73.5 | 0.72309 |
| 74.5 | 0.72031 |
| 75.0 | 0.70057 |
| 75.2 | 0.42904 |
| 73.5 | 0.34844 |
| 70.5 | 0.31443 |
| 62.5 | 0.22521 |
| 53.5 | 0.1833 |
| 22.6 | 0.08029 |
| 75.4* | 0.5625* |

*critical point

### EXAMPLE 6

The following Example relates to using highly porous membranes as masks (e.g., PM2.5 masks). In particular, the following Example relates to a method of using porous membranes as masks to remove airborne particulate matters. The porous membranes may be fabricated according to any of the methods of the present disclosure.

Particulate matter (PM) is an air pollutant consisting of a mixture of solid particles and liquid droplets suspended in the atmosphere. PM can be either directly emitted into the air or formed secondarily in the atmosphere from gaseous precursors. The most important chemical constituents of PM are sulfate, nitrate, ammonium, inorganic ions such as Na⁺, K⁺, Ca²⁺, Mg²⁺, and Cl⁻, etc., organic and elemental carbon, crustal materials, particle-bound water, and heavy metals, etc. Particle size is an important property as it is associated with the origin of the particles, their transport in the atmosphere and their ability to be inhaled into respiratory system. According to the particle size PM is often described as PM10, PM2.5 and PM0.1. PM10 refers to particles with diameter <10 micrometers, PM2.5 with diameter <2.5 micrometers, and PM0.1 with a diameter <0.1 micrometer.

The mass concentrations of PM10 and PM2.5 in ppm level are often used as indicators of air quality. PM2.5 can stay in atmosphere for days to weeks and can be transport up to thousands of kilometers long, while PM10 is more easily deposited and typically travel less than 10 km from their place of generation.

There are increasing evidence to show that both short and long term exposure to particle matters can cause health problems to our respiratory system as well as cardiovascular system. PM2.5 is more hazardous in comparison with PM10 because PM2.5 enters the deepest regions of lung and accumulate over time. It is directly linked to respiratory diseases ranged from aggravated asthma for average people to pre-mature death in people with heart diseases. Joint study involving Health Canada, New York State University School of Medicine, the American Cancer Society concludes that: “Each 10-μg/m³ elevation in fine particulate air pollution was associated with approximately a 4%, 6%, and 8% increased risk of all-cause, cardiopulmonary, and lung cancer mortality, respectively”. It is estimated PM is responsible to a reduction in life expectancy of 8.6 months on average in the 25 countries of the European Union (EU).

According to WHO data, Saudi Arabia has the worst air quality among all countries, with an average PM2.5 level of 108 μg/m³, well above the WHO recommended healthy level of 35.5 μg/m³. Three Saudi big cities, Riyadh, Al Jubail and Damman, are among the worst 15 cities that have the highest PM2.5 level around the world.⁴ The air quality monitored in Jeddah shows that only 8% days in a year have moderate air quality and all the rest days are either unhealthy or very unhealthy.

Personal protective equipment such as air masks and air filter machines are widely used to prevent the inhalation of particulate matters with a world market of around 2.0 billion $/year. However, most of the personal protection masks on the market are only efficient for capturing particulate matters with diameter above 10 microns using high efficiency particulate air (HEPA) filters. For PM2.5 and even smaller particles, the cost of manufacturing HEPA filters is high and the air permeance can significantly drop. For example, the most popular face mask for PM2.5 available in the market is 3M™ N95. According to the studies by Yu et al., Over 90% of 1500 tests of N95 masks failed due to users unaware of the leaks.⁶ The existing membrane technologies are capable to fabricate membranes with pore size smaller than 2.5 μm. These membranes should be able to filter PM2.5 based on size exclusion. However, the challenge of the issue is the membrane permeance, which can be viewed from the following simple estimation. Assuming a personal facemask has a filtration area, A, around 10 cm by 5 cm. In order for people to breathe without any difficulty, the standard pressure drop, ΔP, across the mask cannot exceed 5 mmH₂O/cm² or ˜50 pascal. The average air volume, V, inhaled by an adult is around 600 L/h or 7×10⁻³ mol/s. The required membrane permeance can be estimated from the following equation,

$$P = \frac{V}{A \cdot Δ P} = \frac{7 \times 1 {0}^{- 3}}{10 \times 5 \times 1 {0}^{- 4} \times 50} \approx 0.03 \frac{mol}{{m}^{2} \cdot s \cdot Pa} \approx 1 {0}^{8} GPU .$$

This requirement is about 100 times of the most permeable membranes that have been reported so far with pore size under 1 micrometer. The main reason is because the porous membranes prepared from the existing methods have very low porosity. This permeance restriction explains why the existing membranes cannot enter this market.

Porous Polymer Membranes as PM2.5 Mask. Porous polyvinylidene fluoride (PVDF) or cellulose acetate (CA) with pore size around 100 nm and membrane thickness less than 1 micrometer is fabricated according to the methods of the present disclosure. This membrane is assembled into a regular face mask to efficiently remove PM2.5 from inhalation.

Porous Polymer Membranes as Air Filtration System. Porous PVDF or CA with pore size around 1 micrometer and membrane thickness around 1 micrometer is fabricated according to the methods of the present disclosure. This membrane is assembled into an air filtration system to remove both PM10 and PM2.5.

Other embodiments of the present disclosure are possible. Although the description above contains much specificity, these should not be construed as limiting the scope of the disclosure, but as merely providing illustrations of some of the presently preferred embodiments of this disclosure. It is also contemplated that various combinations or sub-combinations of the specific features and aspects of the embodiments may be made and still fall within the scope of this disclosure. It should be understood that various features and aspects of the disclosed embodiments can be combined with or substituted for one another in order to form various embodiments. Thus, it is intended that the scope of at least some of the present disclosure should not be limited by the particular disclosed embodiments described above.

Thus the scope of this disclosure should be determined by the appended claims and their legal equivalents. Therefore, it will be appreciated that the scope of the present disclosure fully encompasses other embodiments which may become obvious to those skilled in the art, and that the scope of the present disclosure is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

The foregoing description of various preferred embodiments of the disclosure have been presented for purposes of illustration and description. It is not intended to be exhaustive or to limit the disclosure to the precise embodiments, and obviously many modifications and variations are possible in light of the above teaching. The example embodiments, as described above, were chosen and described in order to best explain the principles of the disclosure and its practical application to thereby enable others skilled in the art to best utilize the disclosure in various embodiments and with various modifications as are suited to the particular use contemplated. It is intended that the scope of the disclosure be defined by the claims appended hereto

Various examples have been described. These and other examples are within the scope of the following claims.

1. A method of making a membrane, comprising:
contacting one or more membrane materials, a solvent, and a non-solvent at a first temperature sufficient to form a homogeneous solution;
casting the homogenous solution at about the first temperature;
adjusting the temperature to a second temperature sufficient to induce phase separation of the solvent and non-solvent and cause the one or more membrane materials to redistribute into the solvent; and
immersing in a coagulation bath to form a porous membrane.

2. The method of claim 1, wherein the solvent and non-solvent comprise an upper critical solution temperature system characterized by a critical solution temperature.

3. The method of claim 2, wherein the solvent and non-solvent are miscible at temperatures above the critical solution temperature and immiscible at temperatures below the critical solution temperature.

4. The method of claim 2, wherein the first temperature is a temperature above the critical solution temperature.

5. The method of claim 2, wherein the second temperature is a temperature below the critical solution temperature.

6. The method of claim 1, wherein the solvent and non-solvent form a lower critical solution temperature system characterized by a critical solution temperature.

7. The method of claim 6, wherein the solvent and non-solvent are miscible at temperatures below the critical solution temperature and immiscible at temperatures above the critical solution temperature.

8. The method of claim 6, wherein the first temperature is a temperature below the critical solution temperature.

9. The method of claim 6, wherein the second temperature is a temperature above the critical solution temperature.

10. The method of claim 1, wherein the one or more membrane materials include one or more of a hydrophobic polymer, hydrophilic polymer, and inorganic compound.

11. The method of claim 1, wherein each of the solvent and non-solvent include one or more of an organic solvent, ionic liquid, and water.

12. The method of claim 1, wherein the porous membrane is a polymeric membrane, inorganic membrane, ceramic membrane, or combination thereof.

13. The method of claim 1, wherein the porous membrane includes a porous bulk and a porous surface.

14. The method of claim 1, wherein a pore size of the porous membrane ranges from about 1 nm to about 10 μm.

15. The method of claim 1, further comprising immersing the porous membrane in a coagulation bath.

16. A method of making a porous membrane, comprising;
contacting one or more membrane materials, a solvent, and a non-solvent at a first temperature sufficient to form a homogenous solution, wherein the first temperature is a temperature above an upper critical solution temperature;
casting the homogenous solution at about the first temperature;
adjusting the temperature to a second temperature sufficient to induce phase separation of the solvent and non-solvent and cause the one or more membrane materials to redistribute into the solvent, wherein the second temperature is a temperature below the upper critical solution temperature; and
immersing in a coagulation bath to form a porous membrane.

17. A method of making a porous membrane, comprising:
contacting one or more membrane materials, a solvent, and a non-solvent at a first temperature sufficient to form a homogenous solution, wherein the first temperature is a temperature above a lower critical solution temperature;
casting the homogenous solution at about the first temperature;
adjusting the temperature to a second temperature sufficient to induce phase separation of the solvent and non-solvent and cause the one or more membrane materials to redistribute into the solvent, wherein the second temperature is a temperature below the lower critical solution temperature; and
immersing in a coagulation bath to form a porous membrane.

18. A mask for removing particulate matters, comprising:
a porous polymer membrane formed according to the method of claim 1.

19. The mask of claim 18, wherein the pore size ranges from about 100 nm to about 1 μm.

20. The mask of claim 18, wherein the membrane thickness ranges is about 1 μm.
